(19) United States
(12) Patent Application Publication
(10) Pub. No.: US 2017/0228750 A1
(43) Pub. Date: Aug. 10, 2017

(54) SERVER AND PRICE SETTING SUPPORT METHOD

(71) Applicant: NSK LTD., Tokyo (JP)

(72) Inventors: Tomoaki HIROTA, Kanagawa (JP); Satoshi OZAKI, Kanagawa (JP)

(73) Assignee: NSK LTD., Tokyo (JP)

(21) Appl. No.: 15/494,788

(22) Filed: Apr. 24, 2017

Related U.S. Application Data
(63) Continuation of application No. PCT/JP2016/065078, filed on May 20, 2016.

(30) Foreign Application Priority Data
May 20, 2015 (JP) 2015-102339

(51) Int. Cl. G06Q 30/02; G06Q 50/18

(52) U.S. Cl. CPC G06Q 30/0206; G06Q 50/184

(57) ABSTRACT

A server includes: a receiver configured to receive information transmitted from a terminal; a storage capable of storing first information related to a price of a product or service and second information related to intellectual property of a product or service; a processor configured to identify third information using the information received by the receiver and indicating a specific product or service and using the first information, the third information related to a price of the specific product or service, identify fourth information using the information indicating the specific product or service and using the second information, the fourth information related to intellectual property of the specific product or service, and calculate a price of the specific product or service using the third information; and a transmitter capable of transmitting the calculated price and transmission information including the fourth information to the terminal.

### CROSS-REFERENCE TO RELATED APPLICATIONS

This application is a continuation of International Application No. PCT/JP2016/065078, filed on May 20, 2016 which designates the United States, incorporated herein by reference, and which claims the benefit of priority from Japanese Patent Application No. 2015-102339, filed on May 20, 2015, incorporated herein by reference.

### BACKGROUND

1. Technical Field

The present invention relates to a server and a price setting support method that calculate a price usable as a reference from various types of data to support price setting when a price of a product, a service, or the like is set.

2. Description of the Related Art

A product price setting support device as disclosed in Japanese Patent Application Laid-open Publication No. 2011-238092 (JP-A-2011-238092) is exemplified as a conventional technique. This device is designed for the purpose of, for example, determining a component giving a large effect on the reduction in manufacturing cost and aims to develop the competitiveness by reducing a price owing to cost cutting. An intellectual property economic value calculation system as disclosed in Japanese Patent Application Laid-open Publication No. 2002-197265 (JP-A-2002-197265) is also exemplified as a conventional technique. This system is configured to calculate the economic value of intellectual property relating to a commodity to be assessed in accordance with the degree of contribution on the ground of the economic effect based on an overall feature and overall performance of the commodity.

However, with the product price setting support device described in JP-A-2011-238092, it is not possible for a user to recognize a relationship between a product or a service and intellectual property exploited in providing that product or service. In addition, the intellectual property economic value calculation system described in JP-A-2002-197265 calculates the economic value of intellectual property in accordance with the degree of contribution on the ground of the economic effect based on the feature and the performance but it is difficult to deduce an accurate economic effect.

For the foregoing reasons, there is a need for a server and a price setting support method that allow a user to recognize the relationship between the product or service and the intellectual property used in relation to the offer of the product or service.

### SUMMARY

The present invention includes the following aspects:

(1) A server configured to be communicably connected with a terminal and provide the terminal with information indicating a price of a product or service, the server includes: a receiver configured to receive information transmitted from the terminal; a storage capable of storing first information and second information that are obtained, the first information related to a price of a product or service, the second information related to intellectual property of a product or service; a processor configured to: identify third information using the information received by the receiver and indicating a specific product or service and using the first information, the third information related to a price of the specific product or service, identify fourth information using the information indicating the specific product or service and using the second information, the fourth information related to intellectual property of the specific product or service, and calculate a price of the specific product or service using the third information; and a transmitter capable of transmitting the calculated price and transmission information including the fourth information to the terminal.

(2) A server configured to be communicably connected with a terminal and provide the terminal with information indicating a price of a product or service, the server includes: a receiver configured to receive information transmitted from the terminal; a storage capable of storing first information and second information which are obtained, the first information related to a price of a product or service, the second information related to intellectual property of a product or service; a processor configured to: identify third information using the information received by the receiver and indicating a specific product or service and using the first information, the third information related to a price of the specific product or service, identify fourth information using the information indicating the specific product or service and using the second information, the fourth information related to intellectual property of the specific product or service, and calculate a price of the specific product or service using the third information and the fourth information; and a transmitter capable of transmitting transmission information including the calculated price to the terminal.

(3) A price setting support method for outputting information indicating a price of a product or service by using a computer, the method includes: obtaining first information and second information, the first information related to a price of a product or service, the second information related to intellectual property of a product or service; identifying third information using information indicating a specific product or service and using the first information, the third information related to a price of the specific product or service; identifying fourth information using the information indicating the specific product or service and using the second information, the fourth information related to intellectual property of the specific product or service, and calculating a price of the specific product or service using the third information; and outputting the calculated price and the fourth information.

### BRIEF DESCRIPTION OF THE DRAWINGS

FIG. 1 is a flowchart illustrating an example of a price setting support system, a price setting support program, and a price setting support method according to an embodiment of the present invention;

FIG. 2 is a diagram illustrating an exemplary main configuration of the price setting support system;

FIG. 3 is a diagram illustrating an exemplary configuration of a server;

FIG. 4 is a diagram illustrating an exemplary configuration of a terminal;

FIG. 5 is a diagram illustrating an exemplary configuration of the price setting support program;

FIG. 6 is a diagram illustrating exemplary data included in a customer DB;

FIG. 7 is a diagram illustrating exemplary data included in a cost-related DB;

FIG. 8 is a diagram illustrating exemplary data included in an intellectual property DB;

FIG. 9 is a diagram illustrating exemplary data included in an intellectual property reference DB;

FIG. 10 is a diagram illustrating exemplary data included in a qualified user DB;

FIG. 11 is a diagram illustrating an exemplary login screen;

FIG. 12 is a diagram illustrating an exemplary top page screen;

FIG. 13 is a diagram illustrating an exemplary price calculation target selection screen;

FIG. 14 is a diagram illustrating an exemplary output screen;

FIG. 15 is a diagram illustrating an exemplary abstract information display screen;

FIG. 16 is a diagram illustrating an exemplary output screen displaying intellectual property information including an intellectual property code;

FIG. 17 is a diagram illustrating an exemplary output screen displaying information including a difference price;

FIG. 18 is a diagram illustrating an exemplary output screen displaying information including the difference price;

FIG. 19 is a flowchart illustrating an example of an intellectual property assessment support system, an intellectual property assessment support program, and an intellectual property assessment support method according to another embodiment of the present invention; and

FIG. 20 is a diagram illustrating another exemplary output screen.

### DETAILED DESCRIPTION

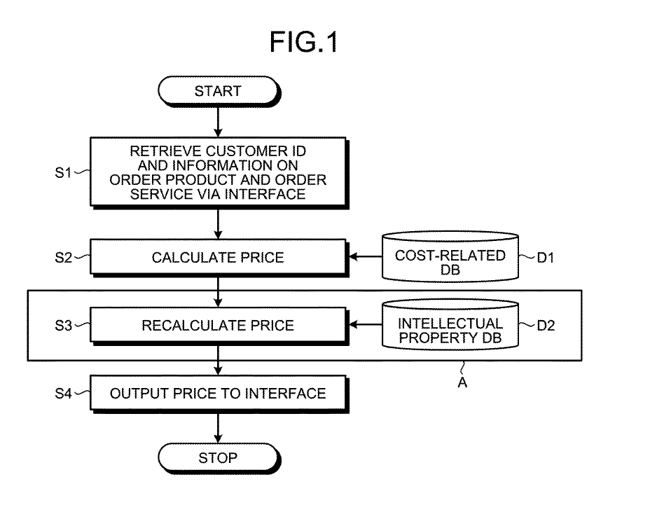

FIG. 1 is a flowchart illustrating an example of a price setting support system, a price setting support program, and a price setting support method according to an embodiment of the present invention. The present embodiment is based on an assumption that a price setter uses an information terminal such as a personal computer, a tablet, or a smartphone (hereinafter, referred to as interface) to start up a program and then obtains information usable as a reference for price setting.

First, the program is started up by an operation “START” for starting the program by the price setter. Next, the procedure proceeds to first step S1 in FIG. 1. Here, for example, a customer ID and information on an order product or order service are retrieved via the interface.

Next, the procedure proceeds to second step S2 in FIG. 1. Here, a price is calculated. At this time, information from a cost-related DB (D1) serving as a database of costs and so on is used. Next, the procedure proceeds to third step S3 in FIG. 1. Here, the price is recalculated. At this time, information from an intellectual property DB (D2) serving as a database of intellectual properties is used. The portion A including the third step S3 and the intellectual property DB (D2) represents the characteristic of this embodiment, where an electronic computer is used in calculation. Next, the procedure proceeds to fourth step S4 in FIG. 1. Here, the calculated price is output to the interface. Subsequently, the program is terminated at “STOP”.

As described above, the price is calculated by taking intellectual property information into account in the price setting support system configured to calculate the price regarding a product or service. The price is calculated by taking the intellectual property information into account in the price setting support program configured to calculate the price regarding a product or service by using the electronic computer. In addition, the price is calculated by taking the intellectual property information into account in the price setting support method configured to calculate the price regarding a product or service by using the electronic computer.

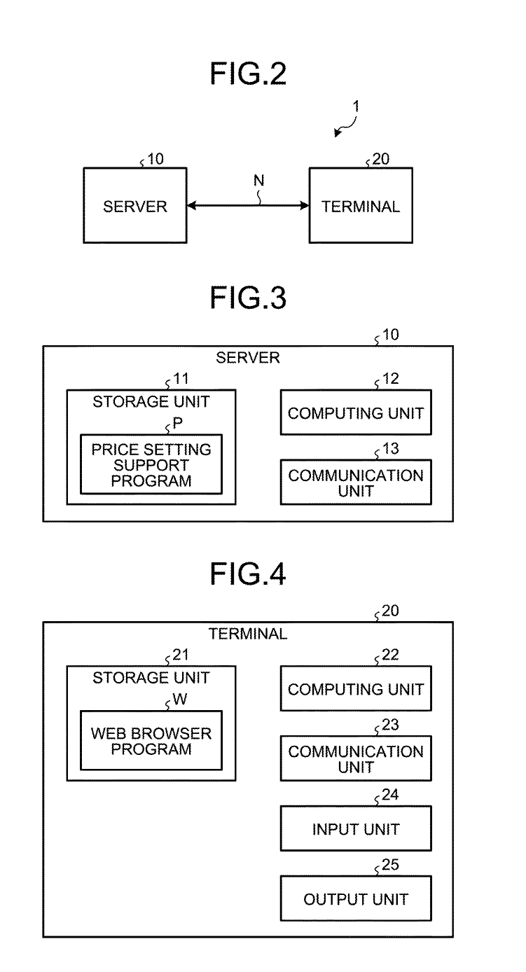

Hereinafter, a price setting support system 1 serving as an embodiment according to the present invention will be described. FIG. 2 is a diagram illustrating an exemplary main configuration of the price setting support system 1. As illustrated in FIG. 2, the price setting support system 1 includes a server 10 and a terminal 20. The server 10 and the terminal 20 are connected via a communication line N so that the server 10 and the terminal 20 can communicate with each other. For example, the communication line N is constructed by one of or a combination of some of a public communication line such as the Internet, a local area network (LAN), a dedicated line, a satellite communication line, and another communication line. A specific form of the communication line N may be wired communication or wireless communication, or alternatively, may be a combination of wired communication and wireless communication. Additionally, a communication agreement (protocol) employed in the communication between the server 10 and the terminal 20 is, for example, TCP/IP but is not limited thereto. An arbitrary communication agreement can be employed as long as the communication can be implemented therewith.

FIG. 3 is a diagram illustrating an exemplary configuration of the server 10. The server 10 is an information processing device including a computer such as a personal computer (a so-called PC) or a work station and includes a storage 11, a computing unit 12, a communication unit 13, and so on. The storage 11 includes, for example, a hard disk drive, a solid state drive, a flash memory, or another storage device to store various types of programs and data relating to the operation of the server 10, including a price setting support program P described later. The storage 11 also includes a random access memory (RAM). The RAM functions as a temporary storage area relating to the execution of a program by the computing unit 12. The computing unit 12 includes a computing device such as a central processing unit (CPU) to perform various types of computational processing relating to the operation of the server 10. Specifically, the computing unit 12 reads the program from the storage 11 to execute the program and then performs various types of processing defined by the program, thereby controlling the operation of the server 10. The communication unit 13 includes a configuration required for the communication, including a circuit for the communication in conformity to a communication standard employed between the server 10 and the terminal 20 such as a network interface controller, to perform various types of processing required for the communication.

FIG. 4 is a diagram illustrating an exemplary configuration of the terminal 20. The terminal 20 is an information processing device including a computer such as a personal computer, a tablet, or a smartphone and includes a storage 21, a computing unit 22, a communication unit 23, an input unit 24, an output unit 25, and so on. Functions and so on of the storage 21, the computing unit 22, and the communication unit 23 are similar to those of the storage 11, the computing unit 12, and the communication unit 13 included in the server 10, respectively, unless otherwise specially mentioned and therefore, the detailed explanation thereof will be omitted. However, the programs and the data stored in the storage 11 of the server 10 differ from programs and data stored in the storage 21 of the terminal 20. The storage 21 of the terminal 20 stores various types of programs and data relating to the operation of the terminal 20, including a program enabling the use of a web browser through the execution thereof (web browser program W). The input unit 24 includes at least one of various types of input devices, such as a touch panel type input device integrated into a display device, a keyboard, and a microphone and performs input processing in accordance with operation content given via the input device. A user of the terminal 20 can perform input on the terminal 20 via the input device included in the input unit 24. The output unit 25 includes at least one of various types of output devices including a display output device such as a liquid crystal display and an audio output device such as a speaker and performs various types of output associated with the operation of the terminal 20.

The terminal 20 exchanges information with the server 10 to function as an interface. To give a specific example, the storage 21 of the terminal 20 according to the embodiment stores an application software program functioning as a web browser. The server 10 according to the embodiment functions as a web server. The user of the terminal 20 can request the server 10 for information by performing input via the web browser, while being able to retrieve information in accordance with a request by performing output via the web browser. The server 10 performs processing in accordance with a request for information transmitted from the terminal 20.

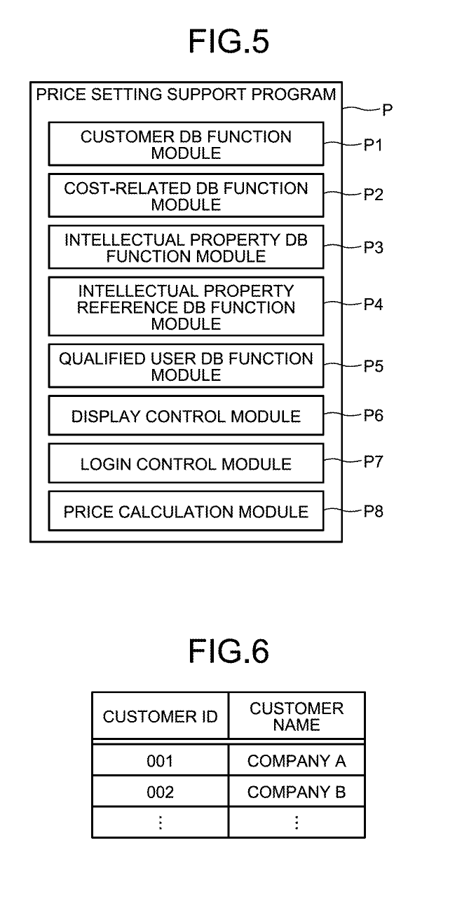

FIG. 5 is a diagram illustrating an exemplary configuration of the price setting support program P. Next, a program stored in the server 10 and a function implemented by the program will be described. The price setting support program P is stored in the storage 11. The price setting support program P is a program for outputting various types of data in accordance with information transmitted in association with a request from the interface. Specifically, the price setting support program P includes, for example, a customer DB function module P1, a cost-related DB function module P2, an intellectual property DB function module P3, an intellectual property reference DB function module P4, a qualified user DB function module P5, a display control module P6, a login control module P7, and a price calculation module P8. Each of the customer DB function module P1, the cost-related DB function module P2, the intellectual property DB function module P3, the intellectual property reference DB function module P4, the qualified user DB function module P5, the display control module P6, the login control module P7, and the price calculation module P8 is a software program installed as part of functions included in the price setting support program P. As described above, the price setting support program P according to the embodiment is organized by combining the plurality of modules. However, this represents an exemplary specific form of the price setting support program P and the form is not limited thereto. For example, two or more of the aforementioned plurality of modules may be provided as dependent software programs.

FIG. 6 is a diagram illustrating exemplary data included in a customer DB. The customer DB function module P1 is a program for causing the server 10 to function as the customer DB. Specifically, as illustrated in FIG. 6 as an example, the customer DB associates a customer ID with a customer name. The server 10, which functions as the customer DB when the customer DB function module P1 is executed, holds data including the customer ID and the customer name of one or a plurality of customers as information on each of the products or services. The customer DB according to the embodiment is a database for storing a set of data that is a combination of respective data items representing the customer ID and the customer name as information on each of the customers.

The customer ID is a unique character string assigned to each of the customers relating to the product or service. The customer name represents a name of a customer relating to the product or service. For example, the name of the customer is a personal name or a corporate name serving as a party to which the product or service is provided. The customer name may further include “xx factory”, “xx office”, and the like. Additionally, for example, in the case of a situation where respective information items on a plurality of offices such as “xx factory” or “xx office” for a customer having one customer name are desired to be managed separately, the customer DB may have an additional attribute (item of data) such as “office name”. The customer DB may also have an additional attribute (item of data) for categorizing the customers. Specifically, “corporate person or individual person”, “store classification”, and the like are exemplified as such an additional attribute. For example, data such as “corporate person” and “individual person” is set in the “corporate person or individual person” attribute, whereby enabling the categorization of the customers. For example, “agency”, “large-scale retail store”, “small-scale retail store”, and the like are set in the “store classification” attribute, whereby enabling the categorization of the customers.

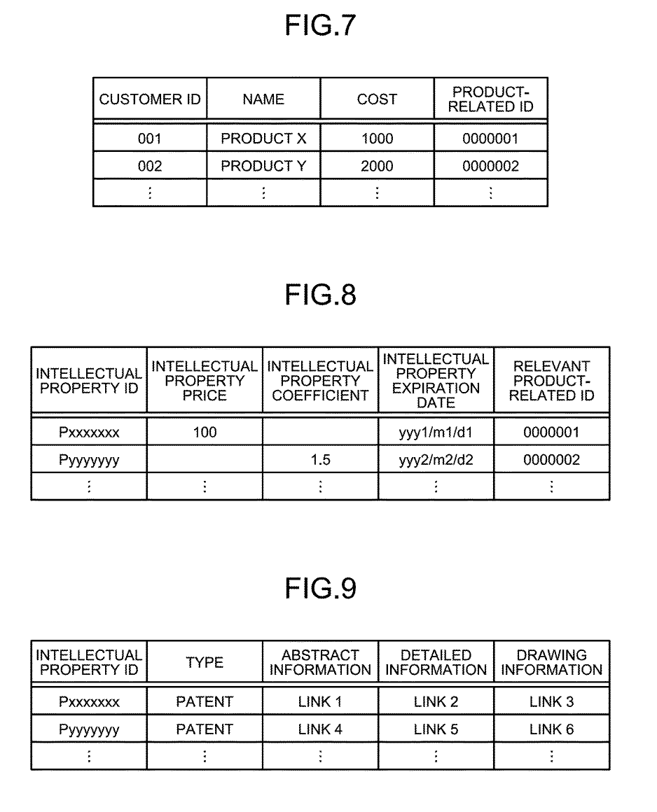

FIG. 7 is a diagram illustrating exemplary data included in the cost-related DB. The cost-related DB function module P2 is a program for causing the server 10 to function as the cost-related DB. Specifically, as illustrated in FIG. 7 as an example, the cost-related DB associates a customer ID, a name, a cost, and a product-related ID with one another. The server 10, which functions as the cost-related DB when the cost-related DB function module P2 is executed, holds data including the customer ID, the name, the cost, and the product-related ID of one or the plurality of products or services as information on the products or services. The cost-related DB according to the embodiment is a database for storing a set of data that is a combination of respective data items representing the customer ID, the name, the cost, and the product-related ID as information on each of the products or services.

The customer ID of the cost-related DB is the same as the customer ID of the customer DB. The name represents a name for locating the product or service such as the name of the product or service and a model number thereof. The cost-related DB may include attributes (items of data) provided separately for the name and the model number of the product or service. The cost represents a cost of the product or service indicated by the name. The product-related ID is a unique character string assigned to the product or service indicated by the name.

Note that there can be a case where the plurality of sets of data are stored in the cost-related DB and include sets of data of which the customer IDs and the costs are solely different from each other while the other attributes (the names and the product-related IDs) are the same. This applies to a case of storing data assuming that, for example, the product or service is provided individually to the customers indicated by the plurality of customer IDs at different prices. Specifically, when the price is set higher or lower for a specific customer because of a certain special agreement or the like and another customer has no such special agreement, the set of data is provided for each of the customers with respect to the same product or service in the cost-related DB.

FIG. 8 is a diagram illustrating exemplary data included in the intellectual property DB. The intellectual property DB function module P3 is a program for causing the server 10 to function as the intellectual property DB. Specifically, as illustrated in FIG. 8 as an example, the intellectual property DB associates an intellectual property ID, an intellectual property price, an intellectual property coefficient, an intellectual property expiration date, and a relevant product-related ID with one another. The server 10, which functions as the intellectual property DB when the intellectual property DB function module P3 is executed, holds data including the intellectual property ID, the intellectual property price, the intellectual property coefficient, the intellectual property live, and the relevant product-related ID of one or the plurality of intellectual property rights as information on the intellectual property rights. The intellectual property DB according to the embodiment is a database for storing a set of data that is a combination of respective data items representing the intellectual property ID, the intellectual property price, the intellectual property coefficient, the intellectual property expiration date, and the relevant product-related ID as information on each of the intellectual property rights.

The intellectual property ID is a unique character string for identifying the intellectual property. For example, the intellectual property ID is identified with a combination of a sign representing a type of the intellectual property right such as a patent right, a utility model right, a design right, and a trademark right, and a number for identifying the intellectual property right. To give a specific example, when the sign representing a patent right is assumed as P, as illustrated in FIG. 8, the intellectual property ID of “Pxxxxxxx” is assigned to a patent right having U.S. Pat. No. ______ as the registration number. Similarly, the individual signs are assigned to other intellectual property rights, including a utility model right, a design right, and a trademark right. Such a method for resolving the intellectual property ID merely represents an example and the method is not limited thereto. The method can be modified as appropriate. The intellectual property DB is only required to have data that sets the intellectual property ID for each of the intellectual property rights as unique information for enabling the intellectual property rights to be identified individually.

The intellectual property price represents a specific amount of money brought about by the intellectual property right. For example, when an extra profit of 100 yen can be added for a certain product or service because of a certain intellectual property right, the intellectual property price associated with the intellectual property ID of that intellectual property right is 100 [yen]. A unit of the intellectual property price is, for example, a unit of a currency of a country in which the price setting support system 1 is utilized. However, this represents an example and the unit is not limited thereto. The unit of the intellectual property price is arbitrary.

The intellectual property coefficient represents a factor for price when the price of the product or service is raised because of the intellectual property right. For example, the intellectual property coefficient is a numerical value equal to or larger than one (1.0). When the intellectual property coefficient is assumed as one in the embodiment, the amount of the profit of the product or service is multiplied by one. In other words, when the intellectual property coefficient is assumed as one, the factor of the profit of the product or service is set to 100% and thus, the price of the product or service does not change regardless of whether the intellectual property right is associated therewith. Compared to this, when the intellectual property coefficient is assumed as 1.5, the amount of the profit of the product or service is multiplied by 1.5. In other words, when the intellectual property coefficient is assumed as 1.5, the factor of the profit of the product or service is set to 150% and thus, the price of the product or service increases because of the intellectual property right. A difference between the intellectual property price and the intellectual property coefficient is whether the amount of the extra profit is expressed as an absolute amount or an amount by the factor and, in other points, intentions to set both of the items are similar to each other.

In the present embodiment, it is assumed that one of the intellectual property price and the intellectual property coefficient is solely set for the intellectual property right indicated by one intellectual property ID and the other is null.

The intellectual property expiration date represents an expiration date of the intellectual property right. The intellectual property expiration date is set to apprise a qualified user described later of the expiration date of the intellectual property right in a case where that intellectual property right is to be invalidated for a certain reason such as elapsed days from an application date of an application for which the intellectual property right has been obtained or the discontinuation of the payment of a fee for maintaining the right. To give a specific example, the intellectual property expiration date is data representing an expiration date of a term of validity of the intellectual property right, namely, a date in year, month, and day format indicating a preceding day of the day when the intellectual property right is to be invalidated.

The relevant product-related ID represents a product or service using the intellectual property for which the intellectual property right has been acquired. To give a specific example, when a product matching an invention (patented invention) for which a patent right “Pxxxxxxx” has been acquired has the product-related ID of “0000001”, the relevant product-related ID associated with the intellectual property ID of that patent right includes “0000001” as illustrated in FIG. 8. The same applies to other intellectual property rights and other products or services. As described above, in the present embodiment, a relationship between the intellectual property right and the product or service is expressed by using a relationship between a set of data in the cost-related DB (in particular, the product-related ID) and a set of data in the intellectual property DB (in particular, the intellectual property ID and the relevant product-related ID). When the product-related ID of the cost-related DB matches up with the relevant product-related ID of the intellectual property DB, the product or service corresponding to that product-related ID and the intellectual property right corresponding to the intellectual property ID associated with the relevant product-related ID have a correlation with each other. Part or all of the data included in the intellectual property DB can function as information indicating a value of the intellectual property relating to the product or service. For example, in regard to the product or service associated with the relevant product-related ID, the intellectual property price, the intellectual property coefficient, the intellectual property expiration date, and other attributes of the intellectual property associated with the relevant product-related ID can function as information indicating a value of the intellectual property relating to the product or service indicated by that relevant product-related ID.

The plurality of relevant product-related IDs may be employed. Specifically, the plurality of product-related IDs may be set for one attribute (item of data) of the relevant product-related ID. Alternatively, attributes in accordance with the number of products relating to the exercise of the intellectual property right may be provided in the intellectual property DB, and one product-related ID may be set individually as a value of each of the attributes. In this case, the attributes in accordance with the number of the products relating to the exercise of the intellectual property right are provided as attributes having serial numbers such as “relevant product-related ID 1” and “relevant product-related ID 2”. Thereafter, character strings same as those of the product-related IDs are set for “relevant product-related ID 1” and “relevant product-related ID 2”, respectively.

FIG. 9 is a diagram illustrating exemplary data included in an intellectual property reference DB. The intellectual property reference DB function module P4 is a program for causing the server 10 to function as the intellectual property reference DB. Specifically, as illustrated in FIG. 9 as an example, the intellectual property reference DB associates an intellectual property ID, a type, and reference information (e.g., abstract information, detailed information, and drawing information) with one another. The server 10, which functions as the intellectual property reference DB when the intellectual property reference DB function module P4 is executed, holds data including the intellectual property ID, the type, the abstract information, the detailed information, and the drawing information of one or the plurality of intellectual property rights as information on the intellectual property rights. The intellectual property reference DB according to the embodiment is a database for storing a set of data that is a combination of respective data items representing the intellectual property ID, the type, the abstract information, the detailed information, and the drawing information as information on each of the intellectual property rights.

The intellectual property ID of the intellectual property reference DB is the same as the intellectual property ID of the intellectual property DB. The type represents a type of the intellectual property. To give an example, when the intellectual property right is a patent right, the type of the intellectual property is set as, for example, “patent”. Similarly, a utility model right, a design right, and a trademark right are set as, for example, “utility model”, “design”, and “trademark”, respectively. The abstract information represents information relating to an abstract of the specific content of the intellectual property for which the intellectual property right has been acquired. To give a specific example, when the intellectual property right is a patent right, the abstract information associated with the intellectual property ID of that intellectual property right is a character string indicating a hyperlink to data representing an abstract of the specific content of the patented invention. The character string indicating the hyperlink is, for example, a uniform resource locator (URL). The data representing the abstract is, for example, an abstract in an official publication such as a patent publication or text data including text copied from the abstract in that official publication and drawing data indicating a representative drawing. However, this represents examples of the abstract and the abstract is not limited thereto. The specific content of the abstract can be modified as appropriate. The detailed information represents information relating to details of the specific content of the intellectual property for which the intellectual property right has been acquired. To give a specific example, when the intellectual property right is a patent right, the information relating to details of the specific content of the intellectual property is text appearing in respective documents such as a patent application form, claims, and a specification for an application for which that patent right has been acquired. The drawing information represents information relating to a drawing depicting the specific content of the intellectual property for which the intellectual property right has been acquired. To give a specific example, when the intellectual property right is a patent right, the drawing depicting the specific content of the intellectual property is a drawing for an application for which that patent right has been acquired. The detailed information and the drawing information are set with a similar intention to that for the abstract information except differences in the specific content. FIG. 9 illustrates character strings “link 1”, “link 2”, and “link 3” indicating the respective hyperlinks for the abstract information, the detailed information, and the drawing information of a patent with the intellectual property ID of “Pxxxxxxx”. Likewise, FIG. 9 illustrates character strings “link 4”, “link 5”, and “link 6” indicating the respective hyperlinks for the abstract information, the detailed information, and the drawing information of a patent with the intellectual property ID of “Pyyyyyyy”.

Note that a provider of the product or service indicated by the set of data stored in the cost-related DB is identical with a right holder of the intellectual property right indicated by the sets of data stored in the intellectual property DB and the intellectual property reference DB. Alternatively, in the case of a plurality of right holders of the intellectual property right, at least one of the right holders is the provider of the product or service. In other words, the price setting support program P according to the embodiment is a program assuming that, when the right holder who has acquired the intellectual property right provides the product or service relating to the exercise of the intellectual property right, the value produced from the intellectual property right is taken into account for the price of the product or service. In addition, the right holder is not limited to a person who has that intellectual property right and can include a person who has obtained a license such as an exclusive license or a non-exclusive license.

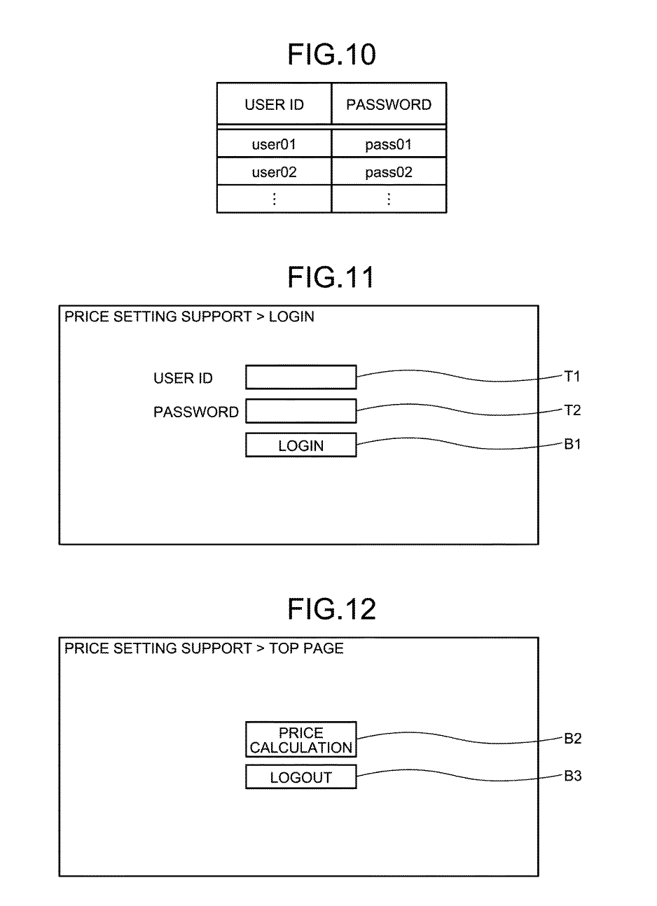

FIG. 10 is a diagram illustrating exemplary data included in a qualified user DB. The qualified user DB function module P5 is a program for causing the server 10 to function as the qualified user DB. Specifically, as illustrated in FIG. 10 as an example, the qualified user DB associates a user ID with a password. The server 10, which functions as the qualified user DB when the qualified user DB function module P5 is executed, holds data including the user ID and the password of at least one qualified user as information on the qualified user. The qualified user DB according to the embodiment is a database for storing sets of data each of which is a combination of respective data items representing the user ID and the password as information on each of the qualified users. The user ID is a unique character string individually assigned to each of the qualified users. The password is a character string used in combination with the user ID in authentication processing for the qualified user.

The display control module P6 is a program for performing processing relating to the display output of information output from the server 10 in relation to the execution of the price setting support program P. Specifically, the display control module P6 is a program for performing the display output relating to the execution of the price setting support program P, for example, in a format that can be displayed by the web browser. More specifically, the display control module P6 is a program for dynamically generating a statement that can be parsed by the web browser, for example, by using a HyperText markup language (HTML). By executing the display control module P6, the server 10 puts information to be output from the server 10 in relation to the execution of the price setting support program P into a state where the information can be displayed by the web browser running in the interface, to output.

FIG. 11 is a diagram illustrating an exemplary login screen. The diagrams in FIG. 11 and other figures illustrating examples of various screens are diagrams illustrating exemplary display content within a window of the web browser running in the interface. For example, when the server 10 is accessed by the interface while executing the price setting support program P, the server 10 transmits initial screen display data for displaying the login screen as illustrated in FIG. 11 to the interface. The interface receives the initial screen display data and then, the web browser running in the interface displays the login screen as illustrated in FIG. 11. The login screen illustrated in FIG. 11 includes two text boxes T1 and T2 for entering the user ID and the password, respectively, and also includes a “login” button B1 for inputting an execution instruction for login. Hereinafter, the screen displayed on the interface in relation to the execution of the price setting support program P is a screen displayed by the interface when instructed by the server 10 which transmits data in accordance with the display content of the screen to the interface while executing the display control module P6.

FIG. 12 is a diagram illustrating an exemplary top page screen. The login control module P7 is a program for performing processing relating to the determination whether a user requesting information via the terminal 20 is a qualified user (authentication processing). For example, when the “login” button B1 in the login screen illustrated in FIG. 11 is operated after the user ID and the password are entered, data representing the user ID and the password is transmitted to the server 10 from the interface. The server 10 executes the login control module P7 to determine whether a set of data corresponding to the combination of the user ID and the password transmitted from the interface is included in the sets of data stored in the qualified user DB.

When a set of data corresponding to the combination of the user ID and the password transmitted from the interface is not included in the sets of data stored in the qualified user DB, the server 10 displays a login error screen (not illustrated) to apprise the user using the interface of not having been authenticated as being a qualified user.

When a set of data corresponding to the combination of the user ID and the password transmitted from the interface is included in the sets of data stored in the qualified user DB, the server 10 approves subsequent access from that interface. This indicates that the user who has accessed from that interface is a price setter approved to use the price setting support system 1. In this case, the server 10 displays the top page screen as illustrated in FIG. 12 as an example. The top page screen illustrated in FIG. 12 includes a “price calculation” button B2 and a “logout” button B3. When the “logout” button B3 in the top page screen is operated, a login state is finished. In this case, the server 10 performs the display control to indicate that the login state has been finished, for example, through the display of a logout screen (not illustrated). The display control after the login state is released is not limited thereto and modifications can be made as appropriate. The top page screen may include apprising information (e.g., “notice”) for the user of the interface such as working conditions of the server of the price setting support system and precautions. In addition, the price setting support program P may be programmed such that, when there is no such apprising information, the top page screen is not displayed and a price calculation target selection screen described later is displayed. Furthermore, although the top page screen has the “logout” button in the example illustrated in FIG. 12 and other screens described later have no “logout” button, the “logout” button may be provided in each screen.

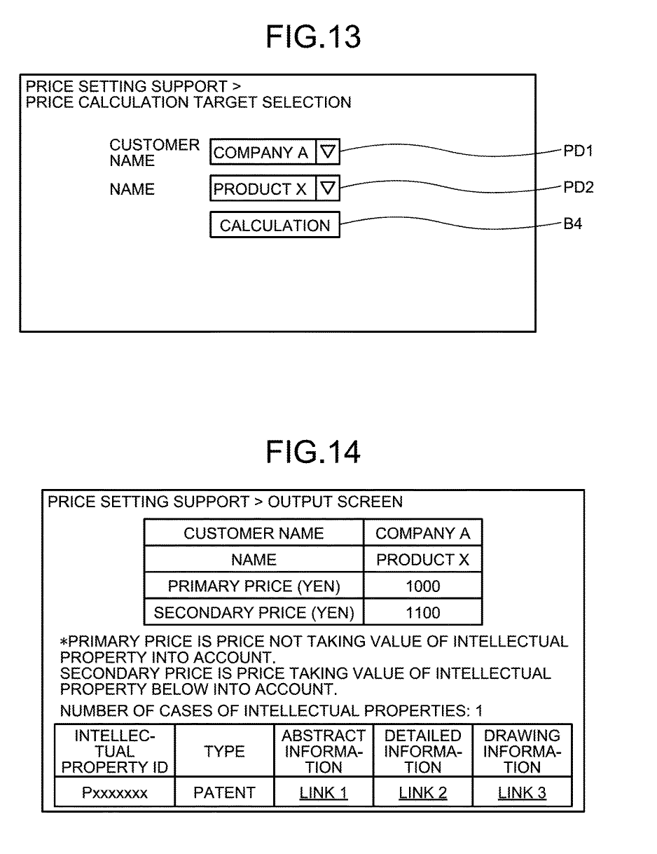

FIG. 13 is a diagram illustrating an exemplary price calculation target selection screen. When the “price calculation” button B2 in the top page screen is operated, the server 10 displays the price calculation target selection screen as illustrated in FIG. 13 as an example. The price calculation target selection screen illustrated in FIG. 13 includes a first specification section PD1 for specifying the customer name, a second specification section PD2 for specifying the name of one product or service, and a “calculation” button B4. The first specification section PD1 and the second specification section PD2 are, for example, pull-down menu type selection specification sections. However, this represents a specific example of the first specification section PD1 and the second specification section PD2, and the specification sections are not limited thereto. The first specification section PD1 and the second specification section PD2 are only required to have input forms with which the user can specify the customer name and the name of the product or service. For example, the first specification section PD1 and the second specification section PD2 may be radio button type selection specification sections, or alternatively, may be text boxes.

Options displayed in the first specification section PD1 are all of the customer names stored in the customer DB. Options displayed in the second specification section PD2 are the names included in the sets of data stored in the cost-related DB, namely, the names of the products or services. When the customer name is specified in the first specification section PD1, the customer ID is uniquely defined. When the name is specified in the second specification section PD2, the product-related ID is uniquely defined. The server 10 extracts, from the cost-related DB, a set of data having both of the customer ID and the product-related ID that have been uniquely defined, thereby being able to locate information regarding a combination of the specified customer and the specified product or service. Note that, in a case where the customer DB has an additional attribute (item of data) such as “office name”, “corporate person or individual person”, and “store classification”, an additional specification section corresponding to such an additional attribute may be provided in the price calculation target selection screen, or alternatively, the price calculation target selection screen may be configured such that a customer can be specified collectively along with the customer name, the office name, and so on at the first specification section PD1. The extraction of data in accordance with the categorization of the customers such as “corporate person or individual person” and “store classification” may be enabled in addition to the data uniquely defined by “customer name” at the first specification section PD1. In this case, all of data matching both of the selected category of the customers and the product or service specified at the second specification section PD2 are assumed as the “combinations of the specified customers and the specified products or services”. Additionally, in a case where the cost-related DB has an additional attribute (item of data) such as “model number”, an additional specification section corresponding to such an additional attribute may be provided in the price calculation target selection screen, or alternatively, the price calculation target selection screen may be configured such that a customer can be specified collectively along with the customer name, the office name, and so on at the second specification section PD2. Furthermore, the price calculation target selection screen may be configured such that the customer name and the name of the product or service can be retrieved through the price calculation target selection screen by using text search. In this case, the price setting support program P includes a program (e.g., a module) for functioning as a search engine. The price setting support program P is configured such that the customer DB and the cost-related DB are searched for a text entered in a text box included in the price calculation target selection screen to extract a matching set of data.

Note that, in some cases, depending on the specific content of the sets of data stored in the cost-related DB, the cost-related DB does not store a set of data corresponding to a combination of the customer ID of the customer name selected and specified in the first specification section PD1 and the product-related ID corresponding to the name selected and specified in the second specification section PD2. For such a situation, the server 10 may be configured to dynamically change the display content of the price calculation target selection screen such that, when the customer name is selected and specified in the first specification section PD1, the options at the second specification section PD2 are limited to the names of the products or services included in the sets of data including the customer ID of the customer name selected and specified in the first specification section PD1 from among the sets of data stored in the cost-related DB, for example. As a matter of course, the customer names may be limited by a similar mechanism when the name of the product or service is specified in the second specification section PD2.

0043 The price calculation module P8 is a program for calculating the price of a price calculation target requested by the user. The price calculation target represents a product or service for the customer specified by the user via the interface. The price calculation target is selected, for example, via the price calculation target selection screen illustrated in FIG. 13. When the “calculation” button B4 in the price calculation target selection screen is operated after the customer name and the name of the product or service are selected, data including the customer ID corresponding to the customer name and information (e.g., the product-related ID) indicating the content such as an order product or an order service corresponding to the name of the product or service is transmitted to the server 10 from the interface. Upon receiving this data, the server 10 executes the price calculation module P8 to perform processing relating to the calculation of the price of the price calculation target. Here, the selection and the specification of the price calculation target by the operation of the “calculation” button B4 in the price calculation target selection screen correspond to the aforementioned “first step S1”.

As processing relating to the calculation of the price of the price calculation target, the server 10 calculates a price not taking an increase in value because of the intellectual property right into account (primary price). The processing relating to the calculation of the primary price corresponds to the aforementioned “second step S2”. Specifically, the server 10 references the cost-related DB to locate a set of data matching the combination of the customer ID and the product-related ID transmitted from the interface. The server 10 reads the cost of the located set of data to calculate the primary price by applying an arithmetic expression including a predetermined variable to this cost. The arithmetic expression including the predetermined variable is, for example, an expression for calculating an amount (profit amount) by performing addition and subtraction or multiplication and division on the cost by using the predetermined variable and then adding the calculated profit amount to the cost. However, such an arithmetic expression serves as an example and the arithmetic expression is not limited thereto. Modifications can be made as appropriate. A value set as the predetermined variable is an arbitrary value set by an administrator of the server 10 by considering the profit. In this case, the administrator of the server 10 may be a person who is authorized to fix the price (price administrator), or alternatively, may be an operator who enters data under the direction of the price administrator. In the embodiment, the server 10 calculates “cost+profit amount” as the primary price by using, for example, the aforementioned arithmetic expression.

In addition, as the processing relating to the calculation of the price of the price calculation target, the server 10 calculates a price taking an increase in value because of the intellectual property right into account (secondary price). The processing relating to the calculation of the secondary price corresponds to the aforementioned “third step S3”. Specifically, for example, the server 10 adds the intellectual property price to the primary price or multiplies the primary price by the intellectual property coefficient to calculate the secondary price. More specifically, the server 10 references the intellectual property DB to locate a set of data including the relevant product-related ID in which a character string same as the product-related ID transmitted from the interface is set. The server 10 reads the intellectual property price or the intellectual property coefficient of the located set of data and then adds the intellectual property price to the primary price or multiplies the “profit amount” used in the calculation of the primary price by the intellectual property coefficient to calculate the secondary price. In other words, the server 10 calculates either “cost+profit amount+intellectual property price” or “cost+(profit amount×intellectual property coefficient)” as the secondary price.

FIG. 14 is a diagram illustrating an exemplary output screen. The server 10 displays the output screen on the interface, the display content of the output screen including the primary price and the secondary price that have been calculated. The processing relating to the display of the output screen corresponds to the aforementioned “fourth step S4”. As illustrated in FIG. 14, for example, the output screen includes the customer name, the name of the product or service, the primary price, the secondary price, and the intellectual property information. The customer name and the name of the product or service included in the output screen are character strings representing the customer name and the name of the product or service specified via the interface. Note that, in a case where an additional attribute (item of data) such as “office name”, “corporate person or individual person”, “store classification”, and “model number” is used, the server 10 further adds information corresponding to these attributes that are input on the price calculation target selection screen to the output screen. The primary price and the secondary price included in the output screen are numerical values representing the primary price and the secondary price calculated by the server 10. As illustrated in FIG. 14, the server 10 may be configured to output text relating to the display content included in the output screen such as a note relating to a difference between the primary price and the secondary price. In this case, a function for outputting such text is included in the price setting support program P in advance.

The intellectual property information included in the output screen includes the content indicating information relating to the intellectual property right used in relation to the calculation of the secondary price. Specifically, for example, the intellectual property information includes the intellectual property ID, the type, the abstract information, the detailed information, and the drawing information. The server 10 reads the intellectual property ID included in the set of data in the intellectual property DB, which has been located in relation to the calculation of the secondary price. The server 10 references the intellectual property reference DB to locate a set of data including the read intellectual property ID. The server 10 outputs the intellectual property ID, the type, the abstract information, the detailed information, and the drawing information included in the located set of data as the intellectual property information on the output screen. Here, the server 10 outputs the abstract information, the detailed information, and the drawing information such that each item of the information functions as a hyperlink. Specifically, for example, the server 10 gives an anchor element to a character string stored in the intellectual property reference DB (i.e., an element a as “<a href=”character string“>character string to be displayed</a>”) to output.

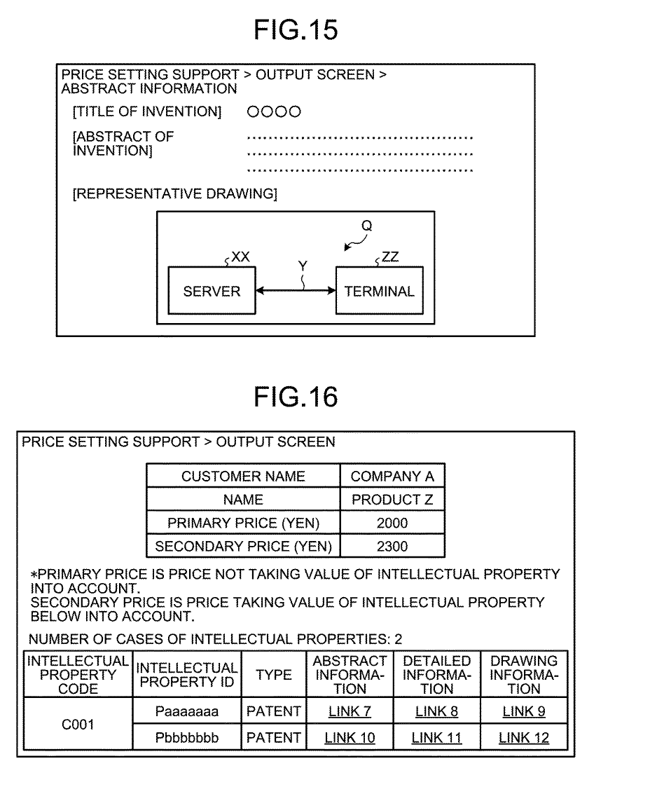

FIG. 15 is a diagram illustrating an exemplary abstract information display screen. When input is performed on the hyperlink to the abstract information displayed on the output screen, the server 10 displays the abstract information display screen including text indicating the abstract of the intellectual property as illustrated in FIG. 15 as an example. Examples of input performed on the hyperlink include click operation on “link 1” and so on with underlines. Although the description with reference to FIG. 15 uses the abstract information as an example, the detailed information and the drawing information are displayed by a mechanism similar to that of the abstract information. In addition, in the description with reference to FIG. 15, a case where the abstract information display screen is displayed as a screen separate from the output screen is described. However, this represents an example of a display mode of the text relating to the content description for the intellectual property and the display mode is not limited thereto. For example, the abstract information and so on displayed via the hyperlink may be displayed within the same window as the output screen. Although the output screen in FIG. 14 includes the respective hyperlinks to the abstract information, the detailed information, and the drawing information, a method for outputting the intellectual property information is not limited thereto. For example, a character string of the intellectual property ID may be the hyperlink to the abstract information such that, when input is performed on this hyperlink, the abstract information (e.g., text of the abstract and the representative drawing) is displayed. Additionally, a “detailed information” button and a “drawing information” button or the hyperlinks thereto may be provided in a screen including such abstract information such that a qualified user who wishes to see further detailed information can browse the detailed information and so on by performed input on these buttons and so on. Furthermore, instead of the hyperlinks to the abstract information, the detailed information, and the drawing information in FIG. 14, the name of the intellectual property such as a title of an invention may be displayed. In this case, the intellectual property DB has an attribute corresponding thereto (e.g., an item of data of “name of intellectual property”), and the name of the intellectual property such as the title of the invention is set for each of the sets of data in the intellectual property DB.

According to the embodiment, the intellectual property information on the product or service is displayed along with a price calculation result, whereby information indicating a relationship between the product or service and the intellectual property exploited in providing that product or service can be provided. As described above, according to the embodiment, it is possible for a user to recognize the relationship between the product or service and the intellectual property exploited in providing that product or service.

In addition, only access from a qualified price setter (e.g., a qualified user) causes the price calculation result and the intellectual property information to be displayed and accordingly, the information can be provided solely to a person who is authorized to see the information regarding the price and the intellectual property. Furthermore, when, for example, only a person who has undergone predetermined education relating to the intellectual property is approved as a qualified price setter, it is possible to provide the information relating to the intellectual property exploited in providing that product or service solely to a person who can more accurately understand the intellectual property. To give a specific example, because a person involved in setting the price for the product or service is a sales representative in many cases, there has been a concern that, for example, the sales representative may tell a client about an intellectual property right possessed by the own company or about exploitation of such an intellectual property right by another company while the presence or absence of a relationship between the product or service and the intellectual property and a specific value of the intellectual property are not sufficiently understood by the sales representative. For the reason of such a concern, there has been a trend of not giving information regarding intellectual property rights to the sales representative deliberately in the past. However, when such a sales representative or the like is subjected to the education regarding the intellectual property and then approved as a qualified price setter after, if necessary, the degree of understanding regarding the intellectual property is confirmed through a qualification test or the like so as to be set as a qualified user according to the present invention, such a concern is eliminated and additionally, the intellectual property can be utilized in setting the price for the product or service. Furthermore, a possibility of the price of the product or service being able to be raised because of the intellectual property can be suggested to the price setter.

In addition, when the price is calculated by taking the intellectual property information into account as in the calculation of the secondary price, it is possible to intelligibly demonstrate that a profit to be gained from the product or service can be further increased through the exploitation of the intellectual property. With this, it is also possible to intelligibly demonstrate the meaning of acquiring and maintaining the intellectual property.

When the intellectual property coefficient is employed as at least one numerical value equal to or larger than 1.0, which can be arbitrarily set, and then, the price is calculated by using the product between the amount of profit (e.g., the primary price) calculated through another method and the intellectual property coefficient, a mechanism relating to the setting of the price of the product or service associated with the exploitation of the intellectual property can be formulated.

Additionally, when the intellectual property price is employed as at least one amount of money that can be arbitrarily set and then, the price is calculated by using the sum of the amount of profit calculated (e.g., the primary price) through another method and the intellectual property price, a mechanism relating to the setting of the price of the product or service associated with the exploitation of the intellectual property can be formulated.

The invention according to the present application is not limited to the aforementioned embodiment and the respective members can be modified as appropriate within the scope of claims. For example, when there is a plurality of products or services, where one with a valid intellectual property and one without a valid intellectual property are mixed, it is preferable to calculate the price such that the one with a valid intellectual property can gain a higher profit. It is also preferable to perform the calculation such that a product or service contained in a valid intellectual property has a higher price than another product of the same type or another service of the same type not contained in a valid intellectual property. Such a calculation is performed through the calculation of the secondary price in a case where the intellectual property price is larger than zero or a case where the intellectual property coefficient is larger than 1.0.

In addition, it is preferable that the intellectual property information include information based on at least one of a patent, utility model, a design, a trademark, a copyright, or a trade secret. With this, the price setting support system 1 capable of dealing with a more number of the intellectual properties can be provided.

It is also preferable that the intellectual property information include the intellectual property coefficient serving as at least one numerical value equal to or larger than 1.0, which can be arbitrarily set, and then, the price be calculated by using the product between the amount of profit calculated through another method and the intellectual property coefficient. Additionally, the intellectual property information may include the intellectual property price serving as at least one amount of money that can be arbitrarily set, and the price may be calculated by using the sum of the amount of profit calculated through another method and the intellectual property price. The amount of profit calculated through another method is, for example, an amount of profit included in the primary price.

Furthermore, it is preferable that the intellectual property coefficient or the intellectual property price be correctable and a correction date and a reason of correction be recordable. It is also preferable that histories of the correction date and the reason of correction be browsable. This is because the competitiveness is reduced in some cases due to the appearance of a competing product or a competing service when the intellectual property coefficient or intellectual property price is kept at its initial value. In such a case, a share can be ensured through revision by, for example, reducing the numerical value of the intellectual property coefficient or the intellectual property price. Specifically, the price setting support system, the price setting support program, and the price setting support method may be configured such that the administrator of the server 10 (e.g., an intellectual property administrator) can correct data stored in the various databases, including the customer DB, the cost-related DB, the intellectual property DB, the intellectual property reference DB, and the qualified user DB. To give a more specific example, the price setting support system, the price setting support program, and the price setting support method may be configured such that the administrator of the server 10 can make corrections such as addition or deletion of a set of data to or from the content stored in the various databases as well as modification of part or all of data included in an existing set of data by using, for example, various commands in a database language such as an SQL or application software for inputting these commands. In this case, the administrator of the server 10 can naturally correct the intellectual property coefficient or the intellectual property price in the intellectual property DB. In addition, the price setting support system, the price setting support program, and the price setting support method may be configured such that the correction date and the reason of correction are recordable when data is corrected in the intellectual property DB or other various databases. Specifically, for example, the various databases including the intellectual property DB may further have attributes (items of data) for the correction date and the reason of correction. In this case, in association with the correction of the database, the administrator of the server 10 sets a date at which a correction has been made in the correction date included in a set in the database that has been corrected and sets a reason for having made a correction in the reason of correction therein. Here, the price setting support system, the price setting support program, and the price setting support method may be configured such that an initial setting date for data and a subsequent correction date therefor are distinguishable from each other. Additionally, the price setting support system, the price setting support program, and the price setting support method may be configured such that a setter and a corrector are recordable. In this case, for example, the various databases including the intellectual property DB may further have attributes (items of data) for the setting date, the setter, the correction date, the corrector, the reason of correction, and the like. The setter represents an initial setter of data and, for example, a name of the administrator of the server 10 or the like is set therein. The setting date represents a setting date for data. The corrector represents a corrector of data and, for example, a name of the administrator of the server 10 or the like is set therein. It is preferable that various pieces of data corresponding to these additional items be input when the database is initially set or every time the database is corrected. Note that, when such a correction and so on is to be made, the input unit such as a keyboard and the output unit such as the display device are connected to the server 10. In other words, when a correction is to be made, a configuration with which data stored in the server 10 is editable is provided to the administrator of the server 10. As a matter of course, a task relating to the correction may be performed remotely by, for example, operation from another computer connected via the communication line N or another network. Administrators of a plurality of types may operate the server 10 as the administrator of the server 10. Specific examples thereof include the aforementioned price administrator, the intellectual property administrator having authority to the content set in the information relating to the intellectual property, and a data administrator who sets or corrects data under the direction of the price administrator and the intellectual property administrator. Dedicated input screens may be provided such that administrators of the plurality of types can set or correct data separately. In this case, the price setting support program P includes a database containing identification information for distinguishing the administrators from one another (e.g., an administrator ID and a password), a program relating to the authentication processing of the administrator, a program for displaying the dedicated input screen in accordance with a result of the authentication processing, a program for modifying the database and so on by translating the content input to this dedicated input screen into various commands, and the like.

As another alternative method, the price setting support program P may further include a correction history recording module. The correction history recording module is a program for checking which of data has been modified when the content stored in the intellectual property DB or other various DBs has been modified and then automatically recording a day on which this modification has been made as the “correction date” of a set of data including the modified data. For example, a start of input relating to the modification of the database causes the server 10 to execute the correction history recording module, and then the server 10 stores a corresponding record in a storage device such as the storage 11 of the server 10. In addition, the server 10 may be configured to display an input window via the output unit of the server 10 when such a “correction date” is recorded, the input window being a window for prompting the administrator of the server 10 to input the reason of correction. When the reason of correction is input, the server 10 associates the correction date and the reason of correction with each other to store to the storage device as a history of correction. The server 10 may be also configured to display this history of correction as being browsable in accordance with operation from the administrator of the server 10 such as the price administrator.

Furthermore, both of the intellectual property price and the intellectual property coefficient may be set for one set of data stored in the intellectual property DB. In this case, for example, the cost-related DB may further have an attribute (item of data) for priority information. The priority information is information indicating how the secondary price is calculated when both of the intellectual property price and the intellectual property coefficient are set. The priority information is expressed by, for example, one of numerical values of 1, 2, 3, and 4. However, this represents a specific example of the priority information, and the priority information is not limited thereto. Modifications can be made as appropriate. The server 10 performs processing in accordance with the priority information when calculating the secondary price for the product or service indicated by a set of data having the product-related ID associated with the intellectual property for which both of the intellectual property price and the intellectual property coefficient are set. To give a specific example, when the priority information is “1”, the server 10 adds the intellectual property price to the primary price to calculate the secondary price. When the priority information is “2”, the server 10 multiplies the primary price by the intellectual property coefficient to calculate the secondary price. In addition, when the priority information is “3”, the server 10 adds the intellectual property price to the primary price and additionally multiplies the resultant value by the intellectual property coefficient to calculate the secondary price. Furthermore, when the priority information is “4”, the server 10 multiplies the primary price by the intellectual property coefficient and additionally adds the intellectual property price to the resultant value to calculate the secondary price. These specific examples can be modified as appropriate. For example, the price setting support program P may be programmed to use one of or both of the intellectual property price and the intellectual property coefficient in accordance with a comparison result between the price of the product or service (e.g., the cost or the primary price) and a predetermined threshold. In other words, a method for obtaining the secondary price may be configured to be changed in accordance with the price of the product or service. As described above, the price to which the value of the intellectual property is applied can be calculated through computation in which at least one of an operation of multiplying the amount of profit of the corresponding product or service calculated through another method by the intellectual property coefficient or an operation of adding the intellectual property price to the amount of profit of the corresponding product or service calculated through the other method is performed, on the basis of the intellectual property information including at least one of the intellectual property coefficient or the intellectual property price, the intellectual property coefficient being a numerical value equal to or larger than 1.0 and arbitrarily settable, and the intellectual property price being the amount of money arbitrarily settable.

It is preferable as well to, when the intellectual property coefficient is set to 1.0 and/or the intellectual property price is set to zero, prompt a user to waive the intellectual property right. This is because both of the numerical values indicate that there is no competitiveness from the viewpoint of the intellectual property, which sometimes means that the possession of the right no longer has the meaning. When the right is waived, the load of maintaining an unnecessary right can be reduced. Specifically, the price setting support program P may further have a notification module. The notification module is a program for notifying the administrator of the server 10 (e.g., the intellectual property administrator) that a predetermined condition has been satisfied in a case where the predetermined condition is satisfied. To give a specific example, when the notification module is executed, information required for the notification such as a mail address of the administrator of the server 10 is made to be able to be input to the server 10. The server 10 stores information required for the notification. When, as a result of the correction and so on, a set of data in the intellectual property DB satisfies a condition that the intellectual property coefficient is set to 1.0, a condition that the intellectual property price is set to zero, or both of the conditions, the server 10 may issue a notification to a notification destination indicated by the information required for the notification to prompt a waiver of the intellectual property right indicated by that set of data.

In addition, it is preferable that the intellectual property coefficient be changed to 1.0 and the intellectual property price be changed to zero on or after the day when the possession of the intellectual property on which the intellectual property coefficient and the intellectual property price are based is ended. In a case where, for example, the intellectual property information is about an intellectual property right having an expiration date or the right is waived, the day when the possession of the intellectual property is ended comes. Consequently, competing products legally come on to the market after that day and it is considered that price competition starts. For such a situation, the setting of a proper value to the intellectual property information is prompted such that a late start for the price competition is avoided. Specifically, for example, the price setting support system 1 may include an expiration date management module. The expiration date management module is a program that checks the presence of a set of data for the intellectual property of which the intellectual property expiration date in the intellectual property DB has expired at a predetermined timing (e.g., 12:00 am) every day and then automatically performs update processing of setting the intellectual property coefficient to 1.0 and setting the intellectual property price to zero for a set of data for the intellectual property of which the intellectual property expiration date in the intellectual property DB has expired.

The intellectual property information may be registered to the existing cost-related database for each of the products or each of the services, or alternatively, may be obtained from another database having the intellectual property information. Specifically, information indicating a correlation to the intellectual property may be added to the existing cost-related DB to make the price setting support system 1 function. For example, the intellectual property ID may be set for each of the sets of data stored in the existing cost-related DB, the intellectual property ID indicating the intellectual property exploited by the product or service of the corresponding set of data. The cost-related DB and the intellectual property DB may be configured as separate units of hardware in the price setting support system 1. In this case, the server 10 acts as a server system in which a plurality of units of hardware works in coordination with each other.

Furthermore, in a price calculation procedure, the price may be calculated first without taking the intellectual property information into account, and then the price may be recalculated with taking the intellectual property information into account by using the result or progress of the first calculation. Alternatively, the price calculation may be performed at once by using the intellectual property information and a calculation expression registered in advance. Specifically, second step S2 and third step S3 may be sequentially performed, or alternatively, second step S2 and third step S3 may be processed in parallel.

In addition, the calculation expression may be, for example, an expression in which a profit obtained by subtracting a cost from the price obtained through the calculation without taking the intellectual property information into account is multiplied by the intellectual property coefficient that is a numerical value equal to or larger than 1.0 and has been registered by the intellectual property administrator. Alternatively, the calculation expression may be an expression in which the intellectual property price that is an amount of money and registered by the intellectual property administrator is added to the price obtained through the calculation without taking the intellectual property information into account.

Besides, when the plurality of intellectual properties relates to one product, the intellectual property administrator may determine the intellectual property coefficient and the intellectual property price by comprehensively making the determination on these intellectual properties. Alternatively, respective intellectual property coefficients of the intellectual properties may be multiplied by each other in calculation, or respective intellectual property prices of the intellectual properties may be added to each other during calculation. Specifically, when the same relevant product-related ID is registered for the plurality of sets of data stored in the intellectual property DB, the product or service indicated by that relevant product-related ID is a product or service relating to the exercise of the plurality of intellectual property rights. In this case, for example, all of the intellectual property prices may be simply added to each other or the “profit amount” may be multiplied by all of the intellectual property coefficients. Alternatively, these amounts may be adjusted in accordance with the number of intellectual property rights having a connection to the price setting for one product or service. For example, the price calculation module P8 may be programmed to have an upper limit for an increase in price caused by the intellectual property right such that an amount over this upper limit is automatically disregarded. For example, the upper limit for an increase in price caused by the intellectual property right is set as an absolute amount or a rate relative to the “profit amount”. However, this represents an example of the upper limit and the upper limit is not limited thereto. The upper limit for an increase in price caused by the intellectual property right can be modified as appropriate.

Furthermore, regarding a calculation result, it is preferable that both of the price obtained through the calculation without taking the intellectual property information into account and the price obtained through the calculation taking the intellectual property information into account be presented. This is achieved by, for example, presenting both of the primary price and the secondary price on the output screen.

Additionally, examples of a target product include a main body of a direct drive motor, a direct drive motor control device, a bearing, a ball screw, a track guide bearing, an actuator, a robot, a sensor, a component for a car such as a steering device or a transmission, and an exposure device. However, any product and service requiring the price setting are applicable as targets.

Although whether a right is possessed in the own country or in a foreign country is not regarded as a problem, it is desirable that the intellectual property information be information grounded on the circumstances regarding the rights in the respective countries. That is, it is desirable that the intellectual property information for each country be kept such that the price can be calculated for each country. Specifically, the intellectual property DB may further have an attribute (item of data) of “country”. Data in “country” represents a country in which the intellectual property right has been acquired. For example, when the aforementioned patent corresponding to the intellectual property ID “Pxxxxxxx” is a patent in Japan, “Japan” is accordingly set for a set of data including the intellectual property ID as data for “country”. In addition, in this case, an item for selecting and specifying “country” is added in the price calculation target selection screen. In the calculation of the secondary price, the server 10 searches the intellectual property DB to locate a set of data in which the product-related ID has the same character string as that of the product-related ID transmitted from the interface is set and at the same time, a country selected through the price calculation target selection screen is set in “country”. Thereafter, the server 10 uses the intellectual property price and the intellectual property coefficient in the located set of data in the calculation of the secondary price.

It is also desirable that, when data regarding the intellectual property information is not yet input and not present, a notice on no input may be given. Specifically, when data is not stored in the intellectual property DB at all or data is certainly stored but includes incomplete data in which part of the set of data is missing, the server 10 may give a notification prompting the administrator of the server 10 (e.g., the intellectual property administrator) to input information regarding the intellectual property right through mail transmission or the like by using, for example, the function of the aforementioned notification module.

Additionally, when the intellectual property coefficient is set to 1.0 and/or the intellectual property price is set to zero, instead of prompting a waiver of that intellectual property right, the maintenance thereof may be prompted in a case where the purpose of the intellectual property right is to prevent a new entry. In this case, it is preferable that a new entry prevention sign can be input as a part of the intellectual property information and that it be browsable. Specifically, the intellectual property DB may further have an attribute (item of data) of “new entry prevention sign”. “New entry prevention sign” serves as a flag value indicating whether a notification is given prompting the user to waive the corresponding intellectual property right when the intellectual property coefficient is set to 1.0 and/or the intellectual property price is set to zero and, for example, is expressed as a binary variable (e.g., 0 or 1). In a case where the value of the new entry prevention sign is 0, the server 10 gives a notification prompting the user to waive the corresponding intellectual property right when the intellectual property coefficient for the corresponding set of data is set to 1.0 and/or the intellectual property price therefor is set to zero. On the other hand, in a case where the value of the new entry prevention sign is 1, the server 10 does not give a notification prompting the user to waive the corresponding intellectual property right even when the intellectual property coefficient for the corresponding set of data is set to 1.0 and/or the intellectual property price therefor is set to zero. In addition, data stored in the various databases such as the content registered in the intellectual property DB including “new entry prevention sign” may be provided as being browsable by using, for example, various commands in a database language such as the SQL or by using application software for inputting these commands.

When the intellectual property information represents a patent, a utility model, a design, or a trademark, it is preferable that progress information such as application, publication, registration, waiver, and expiration be input and that it be browsable. Alternatively, a link to an intra-company database or an external database may be established so that the information is browsable. Specifically, the intellectual property DB may further have an attribute (item of data) regarding the progress information. In this case, examples of the attribute regarding the progress information include “application”, “publication”, “registration”, “waiver”, and “expiration”. “Application” represents the application date of a patent, a utility model, a design, or a trademark (hereinafter, referred to as patent or the like). “Publication” represents the publication date of a patent or the like. “Registration” represents the registration date of a right for a patent or the like. “Waiver” represents a waiver date of the right for a patent or the like. “Expiration” represents an expiration date of the right for a patent or the like. Note that the same information as the expiration of the right can be set in the aforementioned “intellectual property expiration date”. In addition, these pieces of data are not necessarily required to be included in the intellectual property DB and, for example, may be stored in another database (e.g., intra-company database or an external database). In this case, an attribute (item of data) for setting information to link the intellectual property DB and another database to each other may be provided in the intellectual property DB.

Additionally, when the intellectual property information represents a patent, a utility model, a design, or a trademark, a link to an intra-company database or an external database may be established such that an outline of right is browsable. Specifically, the server 10 may be configured to display, in the output screen, information (e.g., a hyperlink) enabling the access to a system including an external database regarding the intellectual property right such as a web site of an industrial property digital library (IPDL). Alternatively, instead of the IPDL, the server 10 may be configured to display, in the output screen and another screen, information enabling the access to another database storing text data representing the outline of the intellectual property right corresponding to the intellectual property ID stored at least in the intellectual property DB.

Furthermore, it is preferable that a correspondence table between a name number, a version, a figure number and so on and a management number or an application number or the like of the intellectual property be included in the intellectual property DB such that the name number, the version, the figure number and so on are coupled with a key during the access to the intellectual property DB used in the price recalculation. This coupling may be managed also as a collection of certain name numbers or the like to which the product codes are allocated. This coupling may be managed also as a collection of the management numbers of certain intellectual properties or the like to which an intellectual property codes are allocated. Specifically, the intellectual property DB may further have an additional attribute (item of data). Examples of the additional attribute include a number used in the publication such as the application number and a publication number, information indicating an original application (e.g., the application number of the original application and the number of the original applications), and the representative drawing. Each of the sets of data in the intellectual property DB can function as the aforementioned correspondence table when further including data representing these attributes. Note that, when the original application does not exist, by setting information indicating that there is no original application (e.g., the number of the original applications: 0), the intellectual property DB can serve as an information source that allow the user to know clearly that there is no original application.

In addition, the intellectual property DB may further have an attribute for the intellectual property code. The intellectual property code is a character string representing a collection of the intellectual properties, which is defined by a predetermined rule to be used in the management of the intellectual properties, and is expressed by a character string unique to each of the collections. To give a specific example, the intellectual property codes different from each other are respectively assigned to a category of the intellectual property having a possibility of being employed for a certain type of product and a category of the intellectual property having a possibility of being employed for another type of product. As described above, grouping the intellectual properties by using the intellectual property codes makes it easier to manage the intellectual properties by purposes or usage. Similarly, the same product code may be configured to be assigned to the products (or the services) belonging to the same category for the purpose of, for example, classifying the products or services into genres. In this case, the cost-related DB includes the product code as an additional attribute. The product code is a character string that represents a collection of the products (or the services) and is defined by a predetermined rule to be used in the management of the products (or the services), and is expressed by a character string unique to each of the collections.

FIG. 16 is a diagram illustrating an exemplary output screen displaying the intellectual property information including the intellectual property code. An intellectual property right having the intellectual property ID “Paaaaaaa” included in the intellectual property information illustrated in FIG. 16 and an intellectual property right having the intellectual property ID “Pbbbbbbb” included therein (two intellectual property rights) are grouped with the same intellectual property code. This indicates that the two intellectual property rights are classified into the same category. Additionally, FIG. 16 illustrates exemplary output of the intellectual property information on the output screen and indicates that the product or service having the name of “product Z” relates to the exercise of two intellectual property rights. In the example illustrated in FIG. 16, as in the example illustrated in FIG. 14, hyperlinks to the abstract information, the detailed information, and the drawing information are provided as information regarding each of the two intellectual property rights such that text data representing these items of the information can be browsed. As another alternative example, when a character string or the like representing the intellectual property ID functions as a hyperlink, for example, that character string or the like may be coupled with text data representing information regarding the intellectual property such as a publication of the intellectual property through that hyperlink. In addition, the intellectual property ID such as “Paaaaaaa” may be an actual number representing the intellectual property right (e.g., U.S. Pat. No. ______), or alternatively, may be a character string or the like representing the title of the invention.

After the price is raised in actuality, received orders may be monitored periodically. If no order is received, the user may be prompted to check whether a competing product infringes the intellectual property. Specifically, for example, the price setting support system 1 may be provided so as to be able to exchange data with a sales management system for managing sales of each of the products or services by customers. The price setting support system 1 may also include an order management module. The order management module is a program for, when the price is raised because of increase in the cost, the intellectual property coefficient, or the intellectual property price, comparing sales of the product or service input from the sales management system between before and after the price is raised and for, when the number of received orders (or an amount of money of received order) decreases below a predetermined threshold after the price is raised, apprising the administrator of the server 10 (e.g., the intellectual property administrator) of the decrease through a contact address thereof by using the function of the aforementioned notification module. A decrease in the received orders to an unnatural extent has a possibility of the existence of another company infringing a valid intellectual property right and providing the product or service relating to the exercise of that intellectual property right at a lower price.

Furthermore, an exclusiveness index given on the ground of the assessment of the exclusive power of the right and a function index given on the ground of the assessment of the function of the right may be incorporated into the intellectual property coefficient. In this case, the intellectual property coefficient is calculated through, for example, the addition or the multiplication between the exclusiveness index and the function index. For example, the exclusiveness index and the function index are numerical values equal to or larger than one (1.0). The exclusiveness index is a numerical value set on the basis of, for example, the degree of difficulty for other company to provide a similar product or service due to the presence of a specific intellectual property right and is set by the intellectual property administrator. The function index is a numerical value set on the basis of, for example, the degree of difficulty for other company to imitate the product or service relating to the exercise of a specific intellectual property right due to the sophistication (e.g., the complication) of that intellectual property right and is set by the intellectual property administrator. The intellectual property DB may further have attributes for the exclusiveness index and the function index.

In addition, an exclusiveness price given on the ground of the assessment of the exclusive power of the right and a function price given on the ground of the assessment of the function of the right may be incorporated into the intellectual property price. In this case, the intellectual property price is calculated through, for example, the addition or the multiplication between the exclusiveness price and the function price. For example, the exclusiveness price and the function price are numerical values representing an amount of money equal to or larger than zero. The exclusiveness price is an amount set on the basis of, for example, the degree of difficulty for other company to provide a similar product or service due to the presence of a specific intellectual property right and is set by the intellectual property administrator. The function price is an amount set on the basis of, for example, the degree of difficulty for other company to imitate the product or service relating to the exercise of a specific intellectual property right due to the sophistication (e.g., the complication) of that intellectual property right and is set by the intellectual property administrator. The intellectual property DB may further have attributes for the exclusiveness price and the function price. The function index and the function price described above may be obtained in consideration of a result of the assessment of the product or the like that is obtained by using a predetermined assessment method with respect to a longer service life, higher safety, the comfortability in use, and so on.

Additionally, when the intellectual property information is based on the plurality of intellectual properties, a coefficient for a contribution rate may be provided for each of the intellectual properties for calculation. It is preferable that the contribution rate can be input, browsed, and corrected. When the contribution rate is provided, an attribute (item of data) for indicating relevance between the cost-related DB and the intellectual property DB is provided in the cost-related DB instead of “relevant product-related ID” of the intellectual property DB. Specifically, additional attributes (items of data) such as “relevant intellectual property ID” and “contribution rate” may be provided in the cost-related DB. Here, “relevant intellectual property ID” out of the additional attributes is provided such that the plurality of intellectual property IDs can be set individually as exemplified as “relevant intellectual property ID 1” and “relevant intellectual property ID 2”. In addition, “contribution rate” out of the additional attributes is provided such that “contribution rate” can be set individually for each of the plurality of “relevant product-related IDs” as exemplified as “contribution rate 1” and “contribution rate 2”. “Contribution rate 1” is a contribution rate of the intellectual property right indicated by the intellectual property ID of “relevant intellectual property ID 1”. “Contribution rate 2” is a contribution rate of the intellectual property right indicated by the intellectual property ID of “relevant intellectual property ID 2”. To give a specific example, when a character string of “Paaaaaaa” and a character string of “Pbbbbbbb” are set for “relevant intellectual property ID 1” and “relevant intellectual property ID 2”, respectively, it is indicated that the product or service indicated by this set of data among the sets of data stored in the cost-related DB is a product or service relating to the exercise of two intellectual property rights indicated by the intellectual property IDs of “Paaaaaaa” and “Pbbbbbbb”. In this case, when executing the price calculation module P8, the server 10 determines additional amounts of the profits because of the respective intellectual property rights of “Paaaaaaa” and “Pbbbbbbb” on the basis of data set in “contribution rate 1” and “contribution rate 2”. Three or more of each of “relevant intellectual property IDs” and “contribution rates” may be handled. However, a sum of all of “contribution rates” needs to be equal to one (100%). In other words, each of the contribution rates is equal to or lower than one. More specifically, the server 10 uses the intellectual property price or the intellectual property coefficient set for each of the plurality of intellectual property rights to individually calculate the additional amount of the profit of each of the intellectual property rights. Next, the server 10 multiplies the respective additional amounts of the profits of the intellectual property rights by the respective contribution rates to reflect the respective contribution rates on the additional amounts. Subsequently, the server 10 adds all of the additional amounts of the respective profits of the plurality of intellectual property rights on which the contribution rates have been reflected to calculate the sum of the additional amounts of the profits, and adds the sum, the cost, and “profit amount” to one another to calculate the secondary price.

Furthermore, the intellectual property information may include costs such as an actual expense and an indirect expense required in acquiring a right such that such costs can be input and browsed. In addition, a recovery rate by the obtained profit relative to the amount of such costs may be browsable. Specifically, the intellectual property DB may further have an attribute for an intellectual property acquisition cost. The intellectual property acquisition cost represents an amount of money of an expense or the like spent in acquiring an intellectual property right. Data for the intellectual property acquisition cost is set by, for example, the administrator of the server 10 (e.g., the intellectual property administrator). When calculating the recovery rate relative to the amount of costs by the profit obtained because of the intellectual property right, the server 10 counts, for example, the number of the sold products or services obtained from the aforementioned sales management system for each of the intellectual property rights for each of which the product-related ID assigned to the corresponding product or service is set as the relevant product-related ID. The server 10 calculates “recovered amount” of each of the intellectual property rights by using the cost of the counted product or service and the intellectual property price or the intellectual property coefficient. The server 10 divides a value of “recovered amount” by a value set in the intellectual property acquisition cost to calculate the recovery rate. The administrator of the server 10 (e.g., the intellectual property administrator) may be notified of the recovery rate by using, for example, the function of the aforementioned notification module.

The price setting support system, the price setting support program, and the price setting support method according to the present embodiment may be used to support the setting of a selling price when the price of the product or service and the intellectual property information are regarding the own company, or alternatively, may be used to support the setting of a purchase price when the price of the product or service and the intellectual property information are regarding other company. In this case, information open to public is mainly used as the intellectual property information. However, non-public information such as contract information may be incorporated thereinto. Specifically, in the description with reference to FIG. 2 to FIG. 16, a qualified user is a user belonging to a provider of the product or service and uses the price setting support system 1 to retrieve information relating to a price to be presented to a customer to whom the product or service is provided. However, this represents an example of the usage of the price setting support system 1 and the usage is not limited thereto. For example, the qualified user may be a user out of users of the product or service and use the price setting support system 1 to retrieve information relating to a price presented by a provider of the product or service. In this case, the customer name in the customer DB is a personal name or a corporate name serving as a provider of the product or service. In other words, the customer DB in this case substantially functions as a provider DB of the product or service. Additionally, in this case, the intellectual property DB is provided so as to mainly store information based on a publicly available publication such as patent information open to public. However, non-public information such as contract information may be further included in the intellectual property DB as information relating to the intellectual property.

Furthermore, because the price can be determined on the ground of a balance between demand and supply, the price may be calculated by incorporating demand information and supply information. Specifically, for example, the price calculation module P8 may be configured such that respective correction coefficients or respective correction prices for the demand information and the supply information can be set in the price calculation module P8. The correction coefficients or the correction prices mentioned above may be defined in advance by the administrator such as the intellectual property administrator, or alternatively, the price calculation module P8 may be configured such that the correction coefficients or the correction prices can be input and specified through the price calculation target selection screen.

The price setting support system 1 may be configured to aggregate the sales results periodically to prompt a user to reward an inventor, a designer, a creator, or an author of the intellectual property with a higher intellectual property coefficient or a higher intellectual property price or the intellectual property with a higher sales price, or a person who has contributed to the acquisition of a right. Specifically, the server 10 may be configured to, by using, for example, the function of the aforementioned notification module, notify the administrator of the server 10 (e.g., the intellectual property administrator) of information (e.g., the intellectual property IDs) indicating a predetermined number of top intellectual property rights (e.g., at a predetermined position and above when counted from the top) having higher recovery rates in the calculation of the recovery rates by using the aforementioned intellectual property acquisition costs. Alternatively, the server 10 may be configured to notify the administrator of the server 10 (e.g., the intellectual property administrator) of information indicating a predetermined number of top intellectual property rights having higher intellectual property prices (or intellectual property coefficients, or both thereof) from among the sets of data stored in the intellectual property DB. In this case, the notified information can be used as “information prompting a user to reward a person who has contributed to the acquisition of the right”. For example, the purpose is achieved when the administrator of the server 10 (e.g., the intellectual property administrator) specifies a person who has derived the intellectual property right (e.g., an inventor of a patented invention in the case of a patent right) from such information indicating the intellectual property rights so as to give a reward thereto.

Additionally, the user may be prompted to compare the intellectual property with a higher intellectual property coefficient or a higher intellectual property price and the intellectual property with a lower intellectual property coefficient or a lower intellectual property price through periodic ranking or the like, study on what way is preferable to acquire the right, and feed the result of the study back to future business to acquire the right. Specifically, in addition to the information indicating a predetermined number of top intellectual property rights described above, the server 10 may be configured to notify the administrator of the server 10 (e.g., the intellectual property administrator) of information indicating a predetermined number of lowest intellectual property rights having lower recovery rates or lower intellectual property prices or the like. In this case, the notified information can be used as “information used for prompting the user to compare right acquisition processes between the intellectual property with a higher intellectual property coefficient or a higher intellectual property price and the intellectual property with a lower intellectual property coefficient or a lower intellectual property price, study on what way is preferable to acquire the right, and feed the result of the study back to future business to acquire the right”. For example, the purpose is achieved when the administrator of the server 10 (e.g., the intellectual property administrator) compares, for example, text representing the content of a predetermined number of top intellectual property rights and text representing the content of a predetermined number of lowest intellectual property rights with each other to study and then utilize as an opportunity usable as a reference for a subsequent activity to acquire an intellectual property right.

The exchange of data between the server 10 and the interface is not limited to the exchange of data via the web browser. For example, the price setting support system 1 may be a system that exchanges information between the server 10 and the interface via an input/output screen provided by dedicated application software that can be executed in the interface.

The customer DB and information according to the customer DB may be omitted. In other words, when a single price is applied to all customers, information for identifying the customer such as the customer ID is unnecessary, while it is also unnecessary to select and specify the customer through the price calculation target selection screen.

Additionally, volume discount may be applied in accordance with a scale of order for the product or service received or placed at once. Specifically, for example, the price calculation target selection screen may have an input item (e.g., a text box) for specifying the quantity of the product or service. In this case, the price calculation module P8 further has a function for calculating the primary price and the secondary price in accordance with the input quantity of the product or service. More specifically, the above-described price calculation module P8 is configured to calculate the price such that, when the input quantity is equal to or larger than a predetermined threshold, the price per one product or service (unit price) is made relatively low compared to the case where the quantity is smaller than the predetermined threshold. To give a specific example, when the input quantity is equal to or larger than the predetermined threshold, the server 10 executing the above-described price calculation module P8 may be configured to subtract a predetermined amount from the profit amount or an amount obtained by increasing the profit amount by an increase in profit because of the intellectual property. Alternatively, when the input quantity is equal to or larger than the predetermined threshold, the server 10 executing the above-described price calculation module P8 may be configured to perform a calculation in which the profit amount or an amount obtained by increasing the profit amount by an increase in profit because of the intellectual property is multiplied by a predetermined coefficient smaller than one. Volume discount can be applied through such processing. In addition, the server 10 may be configured to display the unit price and a total amount side by side on the output screen.

In the embodiment described above, the user ID and the password are set for a qualified user and used as the identification information of the qualified user. However, this represents an example of the identification information and the identification information is not limited thereto. For example, any identification information considered to be inseparable from the user such as a fingerprint, a vein pattern, a retina, and a voiceprint can be used as the identification information of a qualified user according to the present invention. Alternatively, a mechanism for authentication such as a one-time password may be used to authenticate the qualified user according to the present invention.

In the embodiment described above, the server 10 calculates the primary price and the secondary price, while the terminal 20 functioning as the interface displays the primary price, the secondary price, and the intellectual property information regarding the secondary price. However, the processing relating to the primary price may be omitted. Specifically, the server 10 may be configured to calculate the secondary price to transmit this secondary price and information indicating the intellectual property regarding this secondary price to the terminal 20 such that the terminal 20 outputs the secondary price and the intellectual property information regarding the secondary price in accordance with the information transmitted from the server 10.

In the embodiment described above, the description of the encryption of the data included in the database and so on is omitted. However, various types of data used in the present invention may be encrypted as necessary.

Specific data included in the various databases according to the embodiment described above merely serves as an example. Addition, modification, and deletion of the attributes may be applied to these databases as appropriate without departing from the characteristic of the invention.

Part or all of the functions constituting the price setting support program P may be provided by independent hardware such as a dedicated circuit.

The price setting support program P may be provided as being executable in the terminal 20. In this case, the terminal 20 executing the price setting support program P functions as a price setting support device including both of the aforementioned configurations of the server 10 and the terminal 20.

The price setting support program P may be stored in a non-rewritable storage device such as a read only memory (ROM). In addition, the program may be recorded in a recording medium such as an optical medium or a magnetic medium.

The price setting support system 1 may be configured to simultaneously provide prices of two or more products or services and the intellectual property information relating to these products or services. In this case, the price setting support system 1 is programmed such that two or more products or services can be simultaneously selected by using, for example, checkboxes on the price calculation target selection screen.

Furthermore, in the embodiment described above, whether to allow the browsing of the price and the intellectual property information or not is resolved depending on a result of the determination of whether a user is a qualified user. However, the embodiment is not limited thereto. For example, in the case of a user determined not to be a qualified user, the price setting support program P may be programmed to perform processing similar to the case of a qualified user except that the output screen displayed on the interface thereof is configured not to output the intellectual property information. In this case, the user not being qualified can use the top page screen and the price calculation target selection screen in the same manner as a qualified user, while only being able to see the primary price and the secondary price of the selected product or service in the output screen not including the intellectual property information. As described above, only the intellectual property information is not provided to a user other than a qualified user. Therefore, an intellectual property information receiver can be selected more appropriately, while a user such as a sales representative can be supported in setting the price of the product or service. In addition, a user not being able to browse any information provided by the price setting support system, a user being able to browse information other than the intellectual property information (the primary price and the secondary price), and a user being able to browse all of the information including the intellectual property information may be distinguished from one another. In this case, in addition to a qualified user, authentication information on data (e.g., “qualification sign”) corresponding to the user being able to browse information other than the intellectual property information (the primary price and the secondary price) may be further included in the qualified user DB.

Various databases such as the customer DB, the cost-related DB, the intellectual property DB, and the intellectual property reference DB may further have an additional attribute (item of data). Specifically, “award history”, “technical department memo”, “intellectual property department memo”, “management department memo”, “sales memo”, “miscellaneous memo”, and the like are exemplified. For example, data representing a person who has received an award in relation to the intellectual property is set in “award history”. For example, data representing a supplementary note written by a person belonging to a technical department engaged in the creation of the intellectual property and so on is set in “technical department memo”. For example, data representing a supplementary note written by a person belonging to a division that manages the intellectual property is set in “intellectual property department memo”. For example, data representing a supplementary note written by a person belonging to a division that manages the intellectual property, the products and so on or the customer and so on is set in “management department memo”. For example, data representing a supplementary note written by a person who makes sales of the product and so on is set in “sales memo”. Data representing a supplementary note not categorized into a particular attribute (item of data) is set in “miscellaneous memo”. When these additional attributes are set, one or a plurality of pieces of data set in these additional attributes may be browsable in the output screen or a screen relating to the output of the intellectual property information. Specifically, the price setting support program P may be programmed such that the output screen is provided with a button, a hyperlink, or the like corresponding to each of these pieces of data and such that, when input to these buttons and so on is performed, output for displaying corresponding data is performed. In this case, it is desirable that the buttons and so on corresponding to the additional attributes be displayed while being associated with items correlating with the content of the data thereof. For example, “intellectual property department memo” or the like may be displayed in the same line as the intellectual property ID of the matching intellectual property as one item of the intellectual property information, and so forth. The same applies to other attributes.

Incidentally, in a deflation environment, even when the price of a purchased material increases, it is difficult to add the price increase to a product price immediately. In particular, the case of an original equipment manufacturer (OEM) product or component supply is in a situation where, for example, periodic reduction in price is requested and thus, it is fairly difficult to raise the price. Besides, typically, it is not easy for the price setter to understand a relationship between each of the products and the intellectual property. Accordingly, there is a risk where, for example, even a product having a patent is thrown into price competition. It is also not easy to understand the value of the intellectual property such as a patent right that has been acquired. Accordingly, there is a risk where a valuable right is inadvertently waived or a worthless right is unnecessarily maintained. In contrast to this, according to the embodiment of the present invention, the existence of the intellectual property can be indicated to the price setter, thereby being able to prompt the user to set proper price in consideration of the intellectual property. In addition, when a correlation between the acquisition of the intellectual property and the price setting is made easy to understand while a plan-do-check-act (PDCA) cycle is rotated, proper determination on the value of the intellectual property and review of activities for acquiring and maintaining the intellectual property are made possible as a consequence. Furthermore, when the license regarding the invention according to the present application is actively granted, the prices of the products and/or services of respective companies can be raised on the ground of proper evidence and an inflation goal of 2.0% is quickly achieved, which can consequently contribute to ending deflation.

Note that, although the primary price and the secondary price are calculated in the above description, the calculation based on the value of the intellectual property is not limited thereto. For example, a value representing a difference (difference price) between the primary price and the secondary price may be calculated. Specifically, for example, the server 10 may obtain, as a value representing the difference price, at least one of the following: a value obtained by multiplying the primary price by the intellectual property coefficient, a value represented by the intellectual property price, or a value obtained by adding these values to each other. The server 10 may display the value representing the difference price on the terminal 20 along with the primary price and the secondary price.

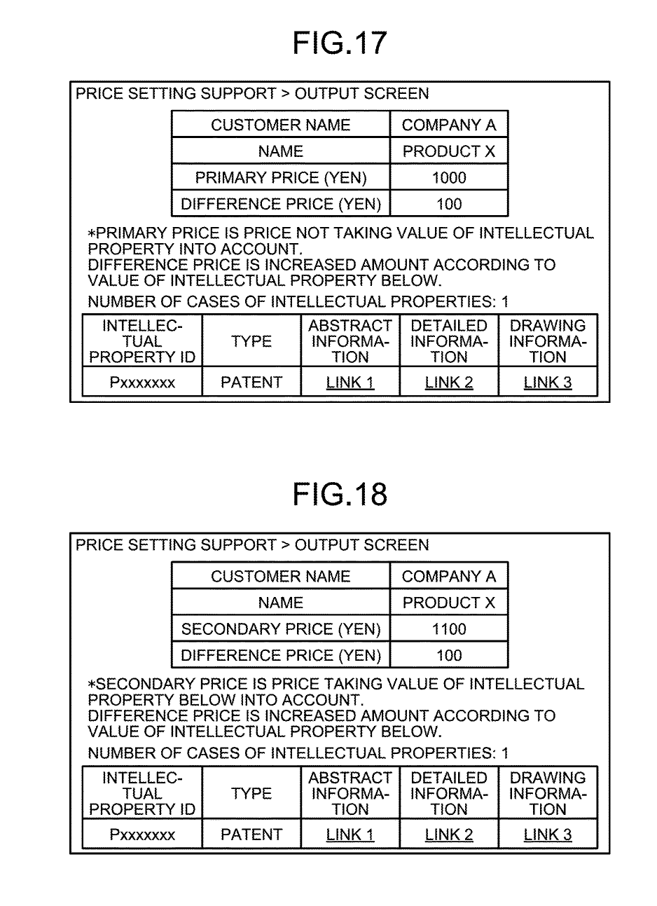

FIG. 17 and FIG. 18 are diagrams illustrating exemplary output screens displaying information including the difference prices. As illustrated in FIG. 17 as an example, when the primary price and the difference price are displayed, the secondary price is derived by adding the primary price to the difference price. Therefore, the user of the terminal 20 can learn the value of the intellectual property and the price of the product or service to which that value is applied. As illustrated in FIG. 18, when the secondary price and the difference price are displayed, the user of the terminal 20 can learn the value of the intellectual property and the price of the product or service to which that value is applied. In this case, the primary price can be also derived by subtracting the difference price from the secondary price.

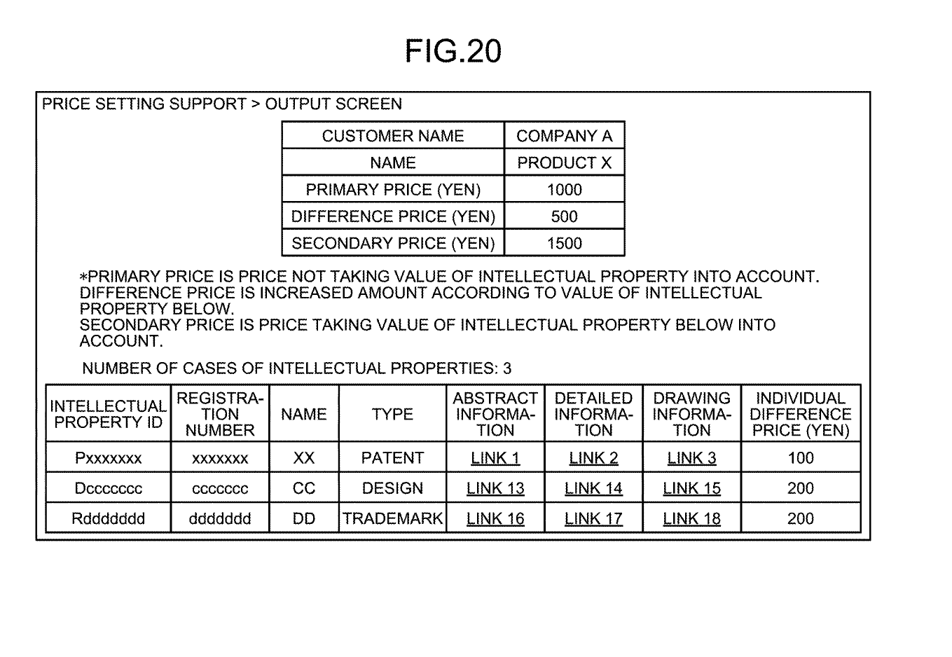

Note that, as illustrated in FIG. 14 and FIG. 16, when the primary price and the secondary price are displayed, the user of the terminal 20 can learn a difference between the primary price and the secondary price and accordingly can learn the value of the intellectual property and the price of the product or service to which that value is applied. In the case of this case, the difference price can be also derived by subtracting the primary price from the secondary price. The server 10 may be configured to display all of the primary price, the difference price, and the secondary price on the terminal 20 (refer to FIG. 20).

In addition, when at least one of the difference price or the secondary price is calculated, it is preferable that the server 10 first calculate the primary price and thereafter, perform recalculation to calculate at least one of the difference price or the secondary price on the basis of that primary price. With this, at least one of the difference price or the secondary price can be calculated with ease on the basis of the calculated primary price and at least one of the intellectual property coefficient or the intellectual property price. The server 10 may be also configured to calculate the primary price and at least one of the difference price or the secondary price in parallel.

An intellectual property assessment support system, an intellectual property assessment support program, and an intellectual property assessment support method according to another embodiment of the present invention use the aforementioned intellectual property coefficient and the aforementioned intellectual property price to support the assessment of the intellectual property. These items with higher numerical values may be ranked such that information thereon is given to an intellectual property assessor. In addition, this ranking information may be stored in the intellectual property DB such that the ranking of the intellectual property is displayed when an inquiry thereabout is made.

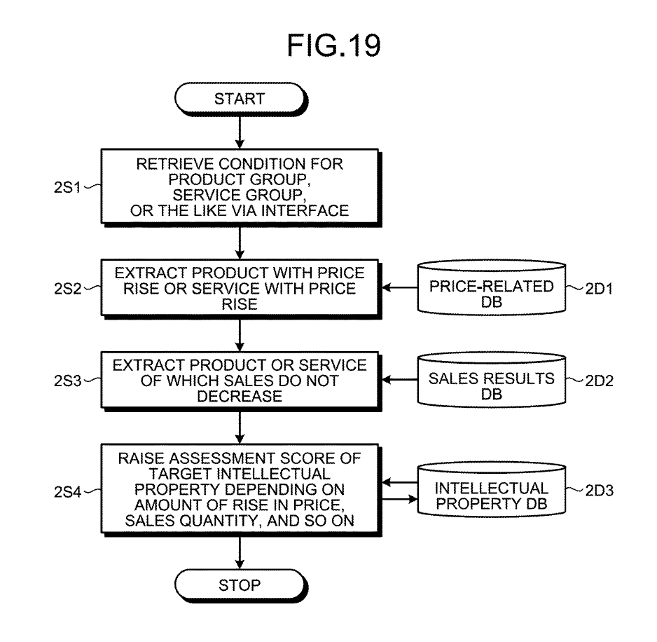

FIG. 19 is a flowchart illustrating an example of the intellectual property assessment support system, the intellectual property assessment support program, and the intellectual property assessment support method according to the embodiment of the invention. The present embodiment is based on an assumption that a price setter (intellectual property assessor) uses an information terminal such as a personal computer, a tablet, or a smartphone (hereinafter, referred to as interface) to start up a program and then obtains information usable as a reference for the assessment of the intellectual property to save the obtained information.

First, the program is started up by an operation “START” for program start by the intellectual property assessor. Next, the procedure proceeds to first step 2S1 in FIG. 19. Here, for example, a condition for a product group or a service group is retrieved via the interface.

Next, the procedure proceeds to second step 2S2 in FIG. 19. Here, a product with price rise or a service with price rise is extracted from a price-related DB (2D1) serving as a database of prices and so on. Next, the procedure proceeds to third step 2S3 in FIG. 19. Here, a product or a service of which the sales do not decrease is extracted from a sales results DB (2D2) serving as a database of sales results and so on. Next, the procedure proceeds to fourth step 2S4 in FIG. 19. Here, the intellectual property treated as a target is extracted from an intellectual property DB (2D3) serving as a database of the intellectual properties such that an assessment score of the target intellectual property is raised depending on, for example, an amount of rise in price, a sales quantity, and the degree of enhancement in a profit rate. The assessment score may be a grade determined by using the aforementioned intellectual property coefficient or the aforementioned intellectual property price. The interface may be configured to receive information on the target intellectual property of which the assessment score has been changed and on the assessment scores thereof before and after the change such that information thereon is given to the intellectual property assessor. These target intellectual properties with higher assessment scores may be ranked such that information thereon is given to the intellectual property assessor. In addition, this ranking information may be stored to the intellectual property DB such that the ranking of the intellectual property is displayed when inquiry thereabout is made. Subsequently, “STOP” is activated by an operation of the intellectual property assessor such as clicking on a “terminate” button and then, the program is terminated.

As described above, the assessment of the intellectual property is supported by using at least one of the intellectual property coefficient or the intellectual property price in the intellectual property assessment support system that supports the assessment of the intellectual property relating to the product or service. The assessment of the intellectual property is supported by using at least one of the intellectual property coefficient or the intellectual property price in the intellectual property assessment support program that supports the assessment of the intellectual property relating to the product or service by using the electronic computer. In addition, the assessment of the intellectual property is supported by using at least one of the intellectual property coefficient or the intellectual property price in the intellectual property assessment support method that supports the assessment of the intellectual property relating to the product or service by using the electronic computer.

When an activity for attempting price rise is performed after the intellectual property is established as a right with respect to the product or service, the intellectual property assessment support system, the intellectual property assessment support program, and the intellectual property assessment support method according to the embodiment work effectively.

The assessment of the intellectual property by the intellectual property assessment support system, the intellectual property assessment support program, and the intellectual property assessment support method may be performed by the price setting support system, the price setting support program, and the price setting support method. In addition, the assessment score is not limited to relative assessment among the plurality of intellectual properties and may be used to express the values of one or more intellectual properties as a value other than a financial price.

FIG. 20 is a diagram illustrating another exemplary output screen. The server 10 may be configured to display information indicating the number of cases of the intellectual properties relating to the product or service on the terminal 20. FIG. 14, FIG. 16 to FIG. 18, and FIG. 20 exemplify a case where a display item of “number of cases of intellectual properties” is displayed on an upper side of a list of the intellectual properties. However, this represents an example of the display and the display is not limited thereto. A specific layout on the display output may be modifiable as appropriate. Note that FIG. 14, FIG. 17, and FIG. 18 exemplify a case where the number of cases of the intellectual properties is one (case). FIG. 16 exemplifies a case where the number of cases of the intellectual properties is two (cases).

Additionally, the server 10 may be configured to display a list of the intellectual properties relating to the product or service on the terminal 20. As illustrated in FIG. 14 and FIG. 16 to FIG. 18 as examples, the list may include the intellectual property ID, the type of the intellectual property, and the hyperlinks to the abstract information, the detailed information, and the drawing information, or alternatively, may include an additional article. In FIG. 20, in addition to the intellectual property ID, the type of the intellectual property, and the hyperlinks to the abstract information, the detailed information, and the drawing information, the registration number of the intellectual property, the name of the intellectual property, and an individual difference price individually representing the difference price brought about by a single intellectual property are included as items of the list of the intellectual properties. However, this represents an example of the items of the list and the items of the list are not limited thereto. The items may be added, modified, or deleted as appropriate. Data corresponding to the items displayed in the list is held by the server 10 as information relating to each of the intellectual property rights as in the case of the aforementioned data representing each of the intellectual property IDs, the types, the abstract information, the detailed information, and the drawing information of one or the plurality of intellectual property rights. More specifically, for example, data corresponding to the items of the list exemplified in FIG. 20 is stored in the storage 11 of the server 10 as data included in the intellectual property DB. In other words, the data included in the intellectual property DB can be modified as appropriate in accordance with the item of data handled as the information relating to the intellectual property.

Note that FIG. 20 illustrates an exemplary display in a case where the number of cases of the intellectual properties is three (cases), where one patent, one design, and one trademark are included in the list. In addition, FIG. 20 exemplifies a case where the sign representing a design right is assumed as D and the intellectual property ID of “Dccccccc” is assigned to a design right having Design No. ccccccc as the registration number. FIG. 20 also exemplifies a case where the sign representing a trademark right is assumed as R and the intellectual property ID of “Dddddddd” is assigned to a trademark right having Trademark No. ddddddd as the registration number. For example, in the case of a patent, the name of the intellectual property corresponds to “title of the invention” appearing in the specification.

Each of the individual difference prices represents an amount of a price increase in the unit price of the product or service brought about by the corresponding intellectual property. Thus, inn a case where the plurality of intellectual properties relates to the product or service, the server 10 may be configured to individually calculate the difference price for each of the plurality of intellectual properties as the individual difference price. In this case, the server 10 may be also configured to calculate the difference price by summing up the individual difference prices. When the individual difference price is displayed, the difference price corresponds to the total sum of the individual difference prices in the list. Note that, although the explanation of the embodiment discloses an example where the primary price, the secondary price, the difference price, and the intellectual property price are expressed by Yen serving as a currency in Japan, this merely represents an example and the expression thereof is not limited thereto. Each of the prices, nominal amounts, and so on may be displayed as a unit with which the value can be recognized, for example, a unit according to a currency other than the currency of Japan.

Additionally, FIG. 20 enumerates the intellectual property ID, the registration number, and the type of the intellectual property in the list. However, this represents an example and the list is not limited thereto. Modifications can be made as appropriate. For example, the registration number and the type of the intellectual property may be displayed by displaying the intellectual property ID constituted by a combination of the sign representing the type of the intellectual property and the registration number. In other words, by informing the users of the terminal 20 of such a configuration rule of the intellectual property ID, more information can be provided with less display content.

The name of the intellectual property is included in the items of the list in FIG. 20. However, this represents an example of a display method for the name of the intellectual property and the display method is not limited thereto. For example, as exemplified in FIG. 15, the server 10 may be configured to perform the display output such that the name of the intellectual property can be displayed in another display output screen referenced by using the hyperlink. Similarly, regarding not only the name of the intellectual property but also other items included in the intellectual property DB as the intellectual property information, the server 10 may be configured to provide the information in a state where indirect display output thereof is enabled via the hyperlink or the like instead of direct display in the list.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A server configured to be communicably connected with a terminal and provide the terminal with information indicating a price of a product or service, the server comprising:
a receiver configured to receive information transmitted from the terminal;
a storage capable of storing first information and second information that are obtained, the first information related to a price of a product or service, the second information related to intellectual property of a product or service;
a processor configured to:
identify third information using the information received by the receiver and indicating a specific product or service and using the first information, the third information related to a price of the specific product or service,
identify fourth information using the information indicating the specific product or service and using the second information, the fourth information related to intellectual property of the specific product or service, and
calculate a price of the specific product or service using the third information; and
a transmitter capable of transmitting the calculated price and transmission information including the fourth information to the terminal.

2. The server according to claim 1, further comprising
an identification information storage capable of storing identification information of a qualified user approved to browse information related to intellectual property of a product or service,
wherein the processor is further configured to determine whether a user of the terminal is the qualified user using the information transmitted from the terminal and the identification information, and
wherein the transmitter is further configured to transmit the transmission information including the fourth information to the terminal only when the user of the terminal is determined to be the qualified user.

3. A server configured to be communicably connected with a terminal and provide the terminal with information indicating a price of a product or service, the server comprising:
a receiver configured to receive information transmitted from the terminal;
a storage capable of storing first information and second information which are obtained, the first information related to a price of a product or service, the second information related to intellectual property of a product or service;
a processor configured to:
identify third information using the information received by the receiver and indicating a specific product or service and using the first information, the third information related to a price of the specific product or service,
identify fourth information using the information indicating the specific product or service and using the second information, the fourth information related to intellectual property of the specific product or service, and
calculate a price of the specific product or service using the third information and the fourth information; and
a transmitter capable of transmitting transmission information including the calculated price to the terminal.

4. The server according to claim 1,
wherein the processor is further configured to calculate the price of the specific product or service using both the third information and the fourth information.

5. The server according to claim 3,
wherein the processor is further configured to:
calculate a first price as a price of the specific product or service without using the fourth information, and
calculate at least one of a difference price or a second price, the difference price calculated using the fourth information and to be added to the first price, the second price being a price of the specific product or service calculated using the fourth information, and
wherein the transmission information includes at least two from among the first price, the difference price, and the second price.

6. The server according to claim 4,
wherein the processor is further configured to:
calculate a first price as a price of the specific product or service without using the fourth information, and
calculate at least one of a difference price or a second price, the difference price calculated using the fourth information and to be added to the first price, the second price being a price of the specific product or service calculated using the fourth information, and
wherein the transmission information includes at least two from among the first price, the difference price, and the second price.

7. The server according to claim 3,
wherein, at least in response to an intellectual property right remaining in force, the fourth information includes a numerical value indicating that the second price is higher than the first price.

8. The server according to claim 4,
wherein, at least in response to an intellectual property right remaining in force, the fourth information includes a numerical value indicating that the second price is higher than the first price.

9. The server according to claim 3,
wherein the intellectual property includes at least one from among a patent, a utility model, a design, a trademark, a copyright, and a trade secret.

10. The server according to claim 4,
wherein the intellectual property includes at least one from among a patent, a utility model, a design, a trademark, a copyright, and a trade secret.

11. The server according to claim 3,
wherein the fourth information includes at least one from among an intellectual property coefficient and an intellectual property price, the intellectual property coefficient being a numerical value equal to or larger than 1.0 and arbitrarily settable and the intellectual property price being an amount of money arbitrarily settable, and
wherein the processor is further configured to calculate the second price by performing at least one from among an operation of multiplying the first price by the intellectual property coefficient and an operation of adding the intellectual property price to the first price.

12. The server according to claim 4,
wherein the fourth information includes at least one from among an intellectual property coefficient and an intellectual property price, the intellectual property coefficient being a numerical value equal to or larger than 1.0 and arbitrarily settable and the intellectual property price being an amount of money arbitrarily settable, and
wherein the processor is further configured to calculate the second price by performing at least one from among an operation of multiplying the first price by the intellectual property coefficient and an operation of adding the intellectual property price to the first price.

13. The server according to claim 11, further comprising:
a receiver configured to receive information for correcting at least one from among the intellectual property coefficient and the intellectual property price; and
a recorder configured to record a correction date and a reason of correction of at least one from among the intellectual property coefficient and the intellectual property price.

14. The server according to claim 12, further comprising:
a receiver configured to receive information for correcting at least one from among the intellectual property coefficient and the intellectual property price; and
a recorder configured to record a correction date and a reason of correction of at least one from among the intellectual property coefficient and the intellectual property price.

15. The server according to claim 11,
wherein the storage is capable of storing information indicating an expiration date of intellectual property, and
wherein the processor is further configured to:
change the intellectual property coefficient to 1.0 in response to the intellectual property coefficient set for the intellectual property of which the intellectual property expiration date has expired, and
change the intellectual property price to zero in response to the intellectual property price set for the intellectual property of which the intellectual property expiration date has expired.

16. The server according to claim 12,
wherein the storage is capable of storing information indicating an expiration date of intellectual property, and
wherein the processor is further configured to:
change the intellectual property coefficient to 1.0 in response to the intellectual property coefficient set for the intellectual property of which the intellectual property expiration date has expired, and
change the intellectual property price to zero in response to the intellectual property price set for the intellectual property of which the intellectual property expiration date has expired.

17. The server according to claim 11, further comprising
a receiver configured to receive information for correcting at least one from among the intellectual property coefficient and the intellectual property price,
wherein the second information includes a new entry prevention flag,
wherein the new entry prevention flag is configured to be one value from among two values, a first value of the two values indicates performing notification prompting a user to waive an intellectual property right, and a second value of the two values indicates not performing notification prompting a user to waive an intellectual property right,
wherein, in response to the intellectual property coefficient becoming 1.0 and/or the intellectual property price becoming zero, the processor is configured to determine whether to prompt a user to waive an intellectual property right using the new entry prevention flag, and
wherein, in response to the processor determining to prompt a user to waive an intellectual property right, the transmitter is capable of transmitting information for prompting the user to waive the intellectual property right.

18. The server according to claim 12, further comprising
a receiver configured to receive information for correcting at least one from among the intellectual property coefficient and the intellectual property price,
wherein the second information includes a new entry prevention flag,
wherein the new entry prevention flag is configured to be one value from among two values, a first value of the two values indicates performing notification prompting a user to waive an intellectual property right, and a second value of the two values indicates not performing notification prompting a user to waive an intellectual property right,
wherein, in response to the intellectual property coefficient becoming 1.0 and/or the intellectual property price becoming zero, the processor is configured to determine whether to prompt a user to waive an intellectual property right using the new entry prevention flag, and
wherein, in response to the processor determining to prompt a waiver of an intellectual property right, the transmitter is capable of transmitting information for prompting the user to waive the intellectual property right.

19. A price setting support method for outputting information indicating a price of a product or service by using a computer, the method comprising:
obtaining first information and second information, the first information related to a price of a product or service, the second information related to intellectual property of a product or service;
identifying third information using information indicating a specific product or service and using the first information, the third information related to a price of the specific product or service;
identifying fourth information using the information indicating the specific product or service and using the second information, the fourth information related to intellectual property of the specific product or service; and
calculating a price of the specific product or service using the third information; and
outputting the calculated price and the fourth information.

20. The price setting support method according to claim 19,
wherein the fourth information includes at least one from among an intellectual property coefficient and an intellectual property price, the intellectual property coefficient being a numerical value equal to or larger than 1.0 and arbitrarily settable and the intellectual property price being an amount of money arbitrarily settable, and
wherein the method further comprises:
calculating a second price by performing at least one from among an operation of multiplying a first price by the intellectual property coefficient and an operation of adding the intellectual property price to the first price, the first price being a price of the specific product or service calculated without using the fourth information and the second price being a price of the specific product or service calculated using the fourth information;
receiving information for correcting at least one from among the intellectual property coefficient and the intellectual property price,
wherein the second information includes a new entry prevention flag,
wherein the new entry prevention flag is configured to be one value from among two values, a first value of the two values indicates performing notification prompting a user to waive an intellectual property right, and a second value of the two values indicates not performing notification prompting a user to waive an intellectual property right;
determining, in response to the intellectual property coefficient becoming 1.0 and/or the intellectual property price becoming zero, whether to prompt a user to waive an intellectual property right using the new entry prevention flag; and
allowing, in response to determining to prompt a user to waive an intellectual property right, output of information for prompting the user to waive the intellectual property right.
